(19) United States
(12) Patent Application Publication
(10) Pub. No.: US 2026/0152254 A1
(43) Pub. Date: Jun. 4, 2026

(54) MODULAR BICYCLE DERAILLEUR

(71) Applicant: SRAM DEUTSCHLAND GBMH, SCHWEINFURT (DE)

(72) Inventors: HENRIK BRAEDT, HAMBACH (DE); SEBASTIAN DUEWELING, MAINBERG (DE); FLORIAN FUHLROTT, BAMBERG (DE); TOBIAS HARCKE, DITTELBRUNN (DE); ALEXANDER LINKE, SCHONUNGEN (DE); MATTHIAS MUELLER, SCHWEINFURT (DE); JOACHIM STUERMER, SCHWEINFURT (DE); MARTIN WEISS, SCHWEINFURT (DE)

(73) Assignee: SRAM DEUTSCHLAND GMBH, SCHWEINFURT (DE)

(21) Appl. No.: 19/457,964

(22) Filed: Jan. 23, 2026

Related U.S. Application Data
(63) Continuation of application No. 18/888,114, filed on Sep. 17, 2024.
Application No. 18/888,114 is a continuation of application No. 17/852,879, filed on Jun. 29, 2022, now Pat. No. 12,122,479.

(30) Foreign Application Priority Data
Jun. 29, 2021 (DE) 10 2021 003 319.1
Jun. 22, 2022 (DE) 10 2022 115 599.4

(51) Int. Cl. B62M 9/125; B62M 9/122; B62M 9/124; B62M 9/126; B62M 9/16

(52) U.S. Cl. CPC B62M 9/125; B62M 9/122; B62M 9/126; B62M 9/16; B62M 2009/12406

(57) ABSTRACT

A rear derailleur is configured as a hierarchical, at least two-level modular construction system and comprises at least several of the modules: “base element module”, “swivel formation module”, “shifting element module”, and “chain guiding device module”. At least one of the modules is replaceable and handleable in one piece. At least one of the modules includes at least one sub-assembly that is replaceable and handleable in one piece. In an embodiment the modular construction system is configured to use at least one family of sub-assemblies comprising at least two family members within at least one of the modules.

Detachable connection interfaces of the family members to adjacent sub-assemblies of the module within the sub-assembly family are configured uniformly across family members for the respective sub-assembly family in such a way that a family member of the sub-assembly family of the module is exchangeable for another family member of the same sub-assembly family that, is for example, of different material, of different design, of different functionality or has different surface properties, while retaining the remaining sub-assemblies of the module.

This application claims priority to, and/or the benefit of, U.S. patent application Ser. No. 18/888,114, filed Sep. 17, 2024, U.S. patent application Ser. No. 17/852,879, filed Jun. 29, 2022, now U.S. Pat. No. 12,122,479, issued Oct. 22, 2024, German patent application DE 10 2021 003 319.1 filed Jun. 29, 2021, and German patent application DE 10 2022 115 599.4 filed Jun. 22, 2022, the contents of which are incorporated by reference herein in their entirety.

### FIELD OF THE DISCLOSURE

The present disclosure relates to bicycle rear derailleurs.

### BACKGROUND

A bicycle is typically equipped with a drive arrangement, such as a chain drive. Such bicycle drive arrangements are used to transmit drive torque from a rider to a rear wheel and to propel the bicycle in this manner. For example, such a drive arrangement may transmit torque from a front chainring assembly to a rear sprocket assembly, such as a sprocket of a multispeed sprocket cassette, to drive the rear wheel. Such drive arrangement is commonly referred to as a bicycle drive train.

In a bicycle drivetrain, front chainring assemblies may have one or more chain wheels, in the industry known as chainrings. Such front chainrings may be attached to a bicycle using a variety of attachment fixtures. For example, a chainring may be attached with chainring bolts, or may be directly connected to the right-hand crank of a bicycle. Rear chain wheels of a bicycle are commonly referred to as sprockets. A plurality of rear sprockets is commonly referred to as a cassette, sprocket cassette, or sprocket set. A sprocket cassette is typically configured to be attached to a freewheel portion of a rear wheel. For this purpose, a sprocket cassette may be attached to a freewheel body of a rear wheel hub, for example, by means of a splined and/or threaded connection.

The horizontal, left/right alignment of a front chainring with a rear sprocket cassette affects the performance of the drive train. For example, a front chainring assembly may have a single chainring aligned with a particular sprocket of the sprocket set of a rear sprocket cassette. When the chain connects the single chainring to this substantially aligned rear sprocket, the chain is under little or no lateral, left/right load. However, when the chain is moved laterally to another sprocket of the cassette, such as by a rear chain derailleur of the drive train, the chain and the entire drive train experience increased lateral loading. Corresponding lateral loads on the chain occur when a front chainring arrangement has several chainrings, where the chain can be moved laterally between these chainrings by a front derailleur as part of the drive train.

For optimal performance of such derailleur drive trains, proper positioning and alignment especially of the rear derailleur on the frame of the bike is particularly important.

The coaxial characteristics of a rear derailleur alignment with respect to the rear wheel can be applied to a rear bicycle derailleur. In particular, components of the rear wheel, specifically the rear hub, can serve as a direct reference for the assembly and alignment of the rear derailleur.

This way, a rear derailleur and a sprocket cassette can be aligned, with respect to a rear axle of the bicycle, both radially and axially to each other and simultaneously to the rear axle. This way, inaccuracies that commonly occur due to tolerance variations and tolerance chains particularly of the rear frame, of the so-called derailleur hanger required for conventional rear derailleurs, and of the rear derailleur itself can be significantly reduced, or even practically eliminated.

Conventionally, rear derailleurs are mounted at the right dropout of a bicycle frame, or generally at the end area of the right chain stay, by means of a derailleur hanger, which is usually a separate part that is attached to the frame. The attachment point of the rear derailleur is then offset radially with respect to the rear wheel axis of the bicycle due to the attachment with a derailleur hanger and is therefore not coaxial with the rear wheel axis.

Especially for bicycle frames made of carbon or aluminum, derailleur hangers have become established which are provided separately and mounted as an additional part, as this arrangement allows the derailleur hanger to be replaced in the event of damage. In steel bicycle frames, the derailleur hanger is often configured in a single piece as part of the rear frame or as part of the right-hand side rear dropout, in this case called a rear frame eye.

In addition to the design advantages of lightweight frames, replaceable derailleur hangers have become established primarily because damage often occurs to conventional bicycle derailleurs in the event of accidents, jamming of the chain or collisions of the rear derailleur with obstacles. In many such cases, damage in the form of bending or breaking can be limited to the derailleur hanger, without additionally severely damaging the frame or the derailleur, which would require costly repair or replacement. However, this certain advantage of the derailleur hanger is countered by a number of disadvantages.

For example, if the derailleur hanger is torn off or severely bent, it must be completely replaced. The continuation of the ride is therefore usually not possible in such cases. Also, the hanger can be deformed in a way such that the rear derailleur is caught by the spokes of the wheel. This can lead to considerable consequential damage to the drive train, the wheel or the frame, and is also not without risk for the rider, for example in the event of the rear wheel locking as a result.

Such derailleur hangers are fixed to the dropout of the rear frame at one end of the derailleur hanger in the area of the rear axle, for mounting on the bicycle, and are connected to a base element (in the industry known as a B-knuckle) of the bicycle derailleur at the other end of the derailleur hanger. The base element of the rear derailleur is usually rotatable relative to the derailleur hanger about the so-called B-axis of the base element, which is parallel to the rear wheel axis but radially offset from it.

These known derailleur hangers differ greatly from each other depending on the manufacturer and mounting method. They can be designed in one piece with the frame or as a separate component. Separate derailleur hangers are either clamped to the frame via quick-release axles or thru axles, or bolted or riveted to the dropout. Furthermore, derailleur hangers can be connected to the frame either on the outside of the right-hand side rear frame dropout, or on the inside.

It is known in the industry that the bicycle market offers hundreds of different and mutually incompatible derailleur hangers alone for the current bicycle models, and even more if previous years'models are considered.

Depending on the frame and derailleur hanger used, this results in the rear derailleur adopting a different position in the radial direction relative to the rear wheel axis and also in the axial direction relative to the sprocket set. Such differences in position in both the axial and radial directions complicate the rear derailleur design as well as the assembly and adjustment of the rear derailleur. The rear derailleur must be adjusted differently depending on the respective frame and derailleur hanger used.

With such known rear frame derailleur eyes or derailleur hangers, there are considerable additional tolerances in the dimensional chain between the sprocket cassette and rear derailleur position, which have a negative effect on the positioning accuracy of the derailleur. In addition, both the radial and the axial position of the rear derailleur depend on the manufacturing quality and the current condition of the derailleur hanger as well as the rear frame.

In other words, any inaccuracy of both the rear frame and the derailleur hanger, or the rear frame derailleur eye, significantly affects the positioning and alignment of the rear derailleur relative to the sprocket cassette.

In addition, derailleur hangers, especially as separate components, are susceptible to damage and often rather unstable. With the ever-increasing rear cassette sprocket sizes and correspondingly larger derailleur dimensions, increased leverage forces occur, which can only be insufficiently absorbed by a replaceable, single-sided derailleur hanger.

Also, the structural stability of most derailleur hangers or derailleur rear frame eyes is no longer able to withstand the demands of today's riding conditions. Even the chain pull that occurs during normal operation can lead to elastic deformation of a derailleur hanger of a magnitude that impairs the positioning accuracy of the rear derailleur relative to the sprockets. Even minor falls or simple overturning of the bicycle often result in plastic deformation of the derailleur hanger, or the rear frame eye formed on the left-hand side rear frame dropout.

Also, the derailleur hanger is an additional component that is individually developed by the frame manufacturer. Often, different hangers are even used by the same manufacturer for the same bicycle frame in order to be able to optimize it for the respective application. This means additional cost and development effort and creates ambiguity in the market as well as with the end user.

These disadvantages of conventional rear derailleur assembly have been known at least since the introduction of replaceable derailleur hangers. However, the problem described above is currently being exacerbated by the trend towards larger cassettes with an ever-increasing number of gears. On the one hand, this results in higher leverage forces on the derailleur hanger due to correspondingly larger sprocket and derailleur dimensions.

An additional factor is the increased stress peaks in the drive train due to chain cage dampers of modern rear derailleurs. The overall longer lever ratios with today's derailleurs thus have an additional negative effect on the positioning accuracy of the derailleur relative to the sprocket cassette. Conversely, the increasing number of gears actually requires increasing the positioning accuracy.

A development that increasingly affects the bicycle market is the general need for a reduction in the consumption of resources in manufacture and usage of technical products. This resource consumption reduction is increasingly being demanded by consumers as well as society and legislators. Social and legislative developments are thus pointing away from a throwaway mentality often encountered in the past and placing increasing demands on the service life and reparability of technical products.

Reference is made in this regard to the German patent application published as DE102018001253A1, to the European patent application published as EP3388324A2, to the Taiwanese patent application published as TW201834921A, to the Chinese patent CN108622302B, and to the U.S. Pat. No. 10,870,464B2, all of which are attributable to the applicant.

From these publications or patents, a rear derailleur is known for coaxial mounting with respect to a rear wheel axis on a bicycle frame.

### SUMMARY

In an embodiment, a rear derailleur for coaxial mounting with respect to a rear wheel axis to a frame dropout of a rear frame is provided. The rear derailleur includes a rigid base element. The rigid base element includes an inner mounting arm having an inner pivot joint for inboard arrangement in the region of the frame dropout and an outer mounting arm having an outer pivot joint coaxially aligned with the inner pivot joint for outboard arrangement in the region of the frame dropout. The base element is connectable to the rear frame so as to be pivotable coaxially about the rear wheel axis by the inner pivot joint and outer pivot joint. The rear derailleur also has a shifting element for changing gears. The shifting element includes a swivel formation pivotably connecting the base element and the shifting element so that the shifting element is translatory pivotably movable relative to the base element pivotably. The rear derailleur also has a chain guide device rotatably and pivotably connected to the shifting element. The chain guide includes an upper chain guide pulley and a lower chain tensioning pulley. The rear derailleur is configured as a hierarchical modular construction system with at least two hierarchical levels.

### BRIEF DESCRIPTION OF THE DRAWINGS

In the following, embodiments of the present disclosure are described by way of example with reference to the figures.

FIG. 1: shows a bicycle with a bicycle derailleur according to prior art in a side view;

FIG. 2: shows an embodiment of a bicycle derailleur according to the present disclosure in an oblique side view;

FIG. 3: shows a rear view of the bicycle derailleur according to FIG. 2 in mounted condition on the right-hand side frame dropout of a bicycle rear frame;

FIG. 4: shows a schematic axial section through frame dropout, rear wheel hub and base element of a bicycle derailleur according to FIGS. 2 and 3;

FIG. 5: shows a rear frame and rear hub as well as bicycle derailleur base element of the bicycle derailleur according to FIGS. 2 and 3 in perspective oblique view;

FIG. 6: shows the body of the bicycle derailleur according to FIGS. 2 and 3 in an oblique perspective side view from inboard;

FIG. 7: shows the bicycle rear derailleur according to FIGS. 2 and 3 in a perspective exploded view with schematic representation of the modular rear derailleur construction system according to the present disclosure;

FIG. 8: shows a base element or B-knuckle of the rear derailleur according to FIGS. 2 and 3 in an oblique inboard view similar to FIG. 6;

FIG. 9: shows the base element or B-knuckle according to FIG. 8 in a perspective view from diagonally outboard, with battery and motor/gearbox removed;

FIG. 10: shows the base element or B-knuckle according to FIGS. 8 and 9 in a perspective exploded view with a view direction according to FIG. 9;

FIG. 11: shows a swivel arm or parallelogram arm of the derailleur according to FIGS. 2 and 3, viewed from outboard;

FIG. 12: shows an exploded, disassembled view of the swivel arm or parallelogram arm according to FIG. 11;

FIG. 13: shows the rear derailleur according to FIGS. 2 and 3, with removed swivel arm or parallelogram arm according to FIGS. 11 and 12 in a representation and view corresponding to FIG. 2;

FIG. 14: shows a motor-gearbox sub-assembly of the rear derailleur according to FIGS. 2 and 3 in an oblique perspective view from outboard;

FIG. 15: shows a motor-gearbox sub-assembly similar to FIG. 14 (with different drive arm) together with a battery device in an oblique perspective view from outboard;

FIG. 16: shows a motor-gearbox sub-assembly according to FIG. 14 or 15 together with a battery device according to FIG. 15 in longitudinal section viewed from inboard;

FIG. 17: shows a motor-gearbox sub-assembly according to FIG. 14 or 15 or 16 in an oblique perspective top view from inboard onto the battery contacts;

FIG. 18: shows a motor-gearbox sub-assembly according to FIG. 14 or 15 to 17 together with a battery device partially separated from the motor-gearbox sub-assembly according to FIG. 15 in an oblique perspective view from outboard;

FIG. 19: shows a motor-gearbox sub-assembly according to FIG. 14 or 15 to 18 in an oblique perspective view from outboard with exploded view of an actuating element;

FIG. 20: shows a motor-gearbox sub-assembly according to FIG. 14 or 15 to 19 in perspective view in a partially disassembled state;

FIG. 21: shows a motor-gearbox sub-assembly according to FIG. 14 or 15 to 20 in the mounted state in a perspective cross-sectional view;

FIG. 22: shows a motor-gearbox sub-assembly according to FIG. 14 or 15 to 21 in the partially mounted state in a perspective longitudinal sectional view;

FIG. 23: shows a motor and gearbox of the motor-gearbox sub-assembly according to FIG. 14 or 15 to 22 in a perspective view;

FIG. 24: shows a backlash-free gear pair of the gear unit according to FIG. 23 in perspective view;

FIG. 25: shows the backlash-free gear pairing according to FIG. 24 in a perspective exploded view;

FIG. 26: shows another embodiment of a bicycle derailleur in an oblique side view enlarged with respect to FIG. 1;

FIG. 27: shows a base element or B-knuckle of the bicycle derailleur according to FIG. 26 in a perspective exploded view diagonally from outboard;

FIG. 28: shows the base element or B-knuckle according to FIG. 27 in a perspective view diagonally from inboard;

FIG. 29: shows a swivel arm or parallelogram arm of the rear derailleur according to FIGS. 26 to 28 in perspective view from inboard;

FIG. 30: shows the swivel arm or parallelogram arm according to FIG. 29 in a disassembled exploded view from inboard;

FIG. 31: shows a shifting element or P-knuckle of a rear derailleur according to FIG. 2 or 26 with spring/damper device screwed out of the receptive housing of the shifting element;

FIG. 32: shows a chain cage guide plate device and spring/damper device screwed out of the receptive housing of the base element similar to FIG. 31 in an exploded view;

FIG. 33: shows a chain guiding device and spring/damper device of the rear derailleur according to FIGS. 26 to 28 as a module that can be handled as a single piece;

FIG. 34: shows a receptive housing of the shifting element or P-knuckle according to FIG. 31 in perspective view of the receptive thread;

FIG. 35: shows various spring/damper devices in the form of modularly interchangeable, one-piece manageable sub-assemblies for a modular rear derailleur similar to FIG. 2 or FIG. 26;

FIG. 36: shows another embodiment of a bicycle derailleur in a rear perspective view from inboard, with a chain tensioning pulley without teeth and associated chain cage;

FIG. 37: shows the bicycle derailleur according to FIG. 36 with chain tensioning pulley and chain cage according to prior art;

FIG. 38: shows the bicycle derailleur according to FIG. 36 in a rear perspective view from outboard; and

FIG. 39: shows the toothless chain tensioning pulley of the rear derailleur according to FIGS. 36 and 38 in two different representations.

### DETAILED DESCRIPTION

Unless explicitly stated otherwise, locational and directional terms used in the present disclosure, such as “left”, “right”, “front”, “rear”, “up”, “down”, etc., relate to the perspective of a rider riding a bicycle. The same applies to locational and directional indications common in the industry such as “inboard” (left or to the left or in the direction of a larger sprocket of a sprocket cassette) and “outboard” (right or to the right or in the direction of a smaller sprocket of a sprocket cassette), which refer to shifting operations, or directions, or sprocket positions, on a sprocket cassette of a bicycle rear wheel.

What is disclosed is a bicycle rear derailleur.

In addition to the coaxial mounting derailleur paradigm described above and as compared with hanger-mounted rear derailleurs, the present disclosure also provides the industry, trade, and end-user with options for manufacturing, providing, repairing and replacing defective or worn individual parts. This can, in part, help to contribute to reducing the consumption of natural resources.

In view the conventional mounting of the rear derailleur on the frame, a rear bicycle derailleur is disclosed. The derailleur is mounted directly, without a derailleur hanger or a rear frame eye, in relation to the rear wheel axle, particularly directly coaxially with the rear wheel axis, on a suitably designed bicycle frame.

For connecting to this bicycle rear derailleur, a suitable bicycle frame has a special interface which, with the participation of an adapter bolt device of the rear derailleur, also serves as an interface for the connection between the frame and the rear axle assembly.

Particularly, the base element or B-knuckle of the rear derailleur is no longer referenced relative to the sprocket set via the lengthy dimensional chain over the derailleur hanger as described above, which can be problematic in terms of the adding-up of tolerances from the sprocket set via the rear axle to the frame and from there via the derailleur hanger to the rear derailleur position. Instead, the dimensional referencing between the rear derailleur and the sprocket set, both axially and radially in relation to the rear axle or the sprocket set, is conducted by means of direct contact between the B-knuckle of the rear derailleur and the hub end cap end face of the rear hub.

This results in high positioning accuracy directly between the rear derailleur and an axial end face of the rear wheel hub, and thus also between the derailleur and the sprocket cassette, the cassette usually being exactly referenced with respect to the rear wheel hub right hand side dimensions. Compared to mounting the rear derailleur on a derailleur hanger or rear frame dropout eye, positioning tolerances of the rear derailleur relative to the sprocket cassette can be achieved that are orders of magnitude smaller, with at the same time high repeatability.

This results in a simplified and standardized interface between the rear derailleur and the bicycle frame across all manufacturers. The need for a derailleur hanger and the associated tolerances and uncertainties, as well as all other disadvantages described above, are eliminated.

The rear derailleur according to the present disclosure comprises a B-knuckle or base element, a shifting parallelogram or swivel formation, a movable P-knuckle or shifting element and a chain cage or chain guiding device.

The swivel formation connects the shifting element to the base element so that it can swivel in translation. The chain guide assembly is rotationally pivotably connected to the shifting element about a pivot axis. The base element includes a first connection end for coaxial mounting to the bicycle frame with respect to the rear wheel axis, and a second connection end for coupling to the swivel formation.

The first connection end of the base element has a first arm and a second arm which are arranged at a distance from one another in the axial direction, with respect to the rear wheel axis, and are set up for mounting the rear derailleur on an associated mounting section or frame dropout of a rear end of a bicycle frame.

In accordance with the genus, the bicycle rear derailleur comprises an inherently rigid base element (inherently rigid in the sense of not containing several assemblies that are articulately hinged to each other) with an inner mounting arm having an inner pivot joint for arrangement on the inboard side at the right hand side rear frame dropout, and with an outer mounting arm having an outer pivot joint coaxial with the inner pivot joint for arrangement on the outboard side at the rear frame dropout.

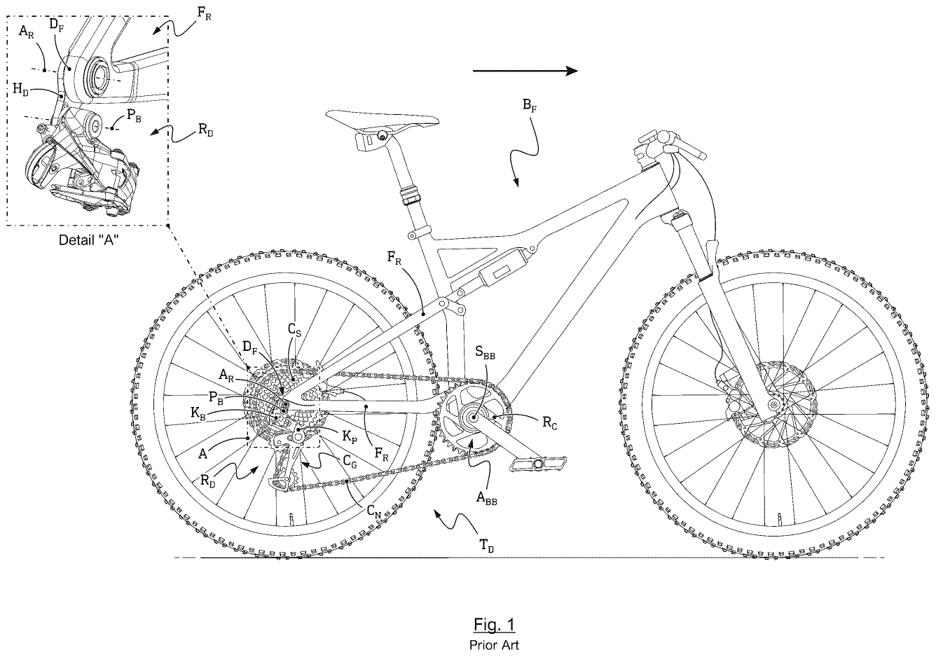

With the inherently rigid base element according to the genus, the rear derailleur according to the present disclosure differs from conventional rear derailleurs described at the outset, in particular in case, for comparative purpose, the frame dropout or derailleur hanger should be attributed to the base element of a conventional rear derailleur. In this case, the base element of a conventional, non-coaxially mounted rear derailleur cannot be regarded as inherently rigid but can be broken down into two assemblies that are articulately hinged to each other by means of the B-axis of the base element (cf. prior art according to FIG. 1 with hanger H_{D} and B-axis P_{B}).

The base element is configured to be connected to the rear frame by means of the pivot joints of the mounting arms so as to be pivotable coaxially about the rear wheel axis.

The rear derailleur according to the present disclosure further comprises a shifting element which, for the purpose of changing gears, is pivotably movable relative to the base element by means of a swivel formation which translationally pivotably connects the base element and the shifting element.

The rear derailleur according to the present disclosure further comprises a chain guiding device that is rotationally pivotably connected to the shifting element and comprises an upper chain guide pulley and a lower chain tensioning pulley.

The rear derailleur according to the present disclosure is characterized by being designed and configured in the form of a hierarchical two-level modular system. For this purpose, the derailleur includes at least several (e.g., at least two) of the modules “base element module”, “swivel formation module”, “shifting element module” and “chain guiding device module” or “chain guide module”. Of the at least several of these modules at least one module is configured to be interchangeable as a unit that can be handled as a single piece. Further, at least one of the modules includes at least one sub-assembly that is configured to be interchangeable as a unit that can be handled as a single piece.

For the purposes of the present disclosure, “one-piece replaceable” or “one-piece handleable” means that a module or sub-assembly can be removed and then handled in one contiguous piece in the removed state.

A module or sub-assembly that disintegrates into several individual parts during or after removal, which thus can no longer be handled in one contiguous piece, thus would not be “replaceable in one piece” or “handleable in one piece” in the sense of the present disclosure.

Modules or sub-assemblies which are connected or connectable to adjacent modules or sub-assemblies by means of additional fastening elements such as screws, pins, rivets etc. can also be considered to be interchangeable or manageable in one piece within the context of the present disclosure. In this case, such additional fastening elements are not to be regarded as components or parts of the respective one-piece handleable module or assembly.

In an embodiment, at least one one-piece interchangeable sub-assembly consists of a plurality of at least three interconnected individual parts. For the purpose of the present disclosure, connecting elements such as screws, pins, rivets, etc., that are used to connect the individual parts of a sub-assembly to one another are not counted as individual parts of the sub-assembly.

The at least two-level hierarchical modular design of the rear derailleur, comprising hierarchically superordinate modules and hierarchically subordinate sub-assemblies within the modules, allows for easy disassembly, repair and/or conversion/upgrade of the derailleur, due to the at least one module and sub-assembly (or several or all modules and sub-assemblies contained in the modules) being configured as to be exchangeable and handleable in one piece.

This way, it is not necessary anymore to replace the entire rear derailleur, for example in the event of damage, or in order to upgrade the technology of the rear derailleur. Nor is it necessary to completely disassemble the entire rear derailleur or at least parts of the rear derailleur in order to replace modules or sub-assemblies. Rather, due to the hierarchical modular construction system whereby modules and sub-assemblies are configured to be exchanged and handled as a single piece, only the affected module or sub-assembly has to be detached from, or reconnected to, the adjacent modules or sub-assemblies of the derailleur.

In another embodiment the modular construction system is configured for the usage of at least one sub-assembly family within at least one of the aforementioned modules, the at least one sub-assembly family comprising at least two sub-assembly family members in the form of interchangeable sub-assemblies. For this purpose, connection interfaces of the sub-assembly family members for detachable connection with adjacent sub-assemblies of the at least one module (as well as, additionally or alternatively, if present at the respective sub-assembly, connection interfaces to adjacent modules) within the at least one sub-assembly family (in case of several sub-assembly families for a specific module for each sub-assembly family) are configured uniformly across all family members of the at least one sub-assembly family.

This way, a family member of the at least one sub-assembly family of the at least one module can be exchanged for another family member of the same sub-assembly family. The exchanged family member can, for example, consist of varied materials, be of different design, comprise different functionalities or be of a different surface quality, while at the same time retaining all other sub-assemblies of the at least one module.

This exchange of a family member for another family member of the same sub-assembly family can, for example, already be provided for by the manufacturer during production planning, which makes it comparatively easy to plan, provide for and produce a variety of different embodiments or quality levels of the rear derailleur.

Due to the provision of standardized connection interfaces across all family members, this exchange can also be conducted by the bicycle trade, by specialist workshops and even by the end user at any time with little effort. This way, the derailleur according to the present disclosure can meet the increasing demands on the part of society and legislators for improvements to the reparability of technical goods and for reducing the consumption of natural resources significantly better than a derailleur according to prior art.

For example, the base element module can comprise at least one base element sub-assembly that is configured to be a member of a base element sub-assembly family. This means that the connection interfaces of the base element sub-assembly follow a uniformly defined standard for the base element sub-assembly family to which the at least one base element sub-assembly is assigned. This makes it possible for the base element sub-assembly to be easily separated from the rear derailleur or from the base element, for example, in order to be replaced by a base element sub-assembly from the same sub-assembly family, or in order to repair the base element sub-assembly in the event of damage.

In another embodiment, the modules or sub-assemblies of the rear derailleur are configured to be replaceable without tools, or with standard household tools, and thus easily also by an end user, for example. This also enables the customer or end user to repair their bicycle derailleur with little effort, or to renew worn parts, thus increasing the useful lifespan of the derailleur. Furthermore, it is possible to replace sub-assemblies or modules of the rear derailleur with corresponding sub-assemblies or modules of higher quality or with additional features, for example, in order to obtain a higher-quality product at low to moderate cost, without having to purchase a completely new rear derailleur and to dispose of the old derailleur.

Using the base element module as an example, at least one sub-assembly of the base element module may be in the form of an interchangeable inner or outer mounting arm. This arm can be designed as a member of a base element sub-assembly family, for example as a member of a base element sub-assembly family named “Inner mounting arm sub-assembly family” or as a member of a base element sub-assembly family named “Outer mounting arm sub-assembly family”. With this sub assembly family membership, the mounting arm has connection interfaces for detachable connection to adjacent base element module sub-assemblies (as well as to adjacent modules, if applicable) that are uniformly designed within the respective sub-assembly family. This way, a modular base element or B-axis is obtained whose subassemblies are easily removable, replaceable, repairable or upgradable.

In another embodiment, at least one mounting arm of the base element module, is formed as a pressed or stamped part formed from a substantially flat blank. This is in comparison with the prior art, in which the B knuckle or base element frequently consists of a one-piece component that is geometrically complex and costly to produce, for example cast and/or milled from a single piece.

In another embodiment, at least one mounting arm of the base element module is essentially formed from a fiber composite material. By forming one or both mounting arms of the base element or B-knuckle from a fiber composite material (e.g., glass fiber-reinforced or carbon fiber-reinforced resin or thermoplastic material) a high-strength and lightweight base element is obtained.

Due to the modularity of the base element, it is also possible to produce series for different price points, for different target groups, or for different target markets by selecting materials with different densities and strengths or different manufacturing methods, or surface qualities for the individual sub-assemblies of the at least one sub-assembly family of the base element module.

In another embodiment, at least one sub-assembly of the base element module is designed as an exchangeable cover element. The exchangeable cover element protects at least areas of the base element module (or in an embodiment a member of a base element sub-assembly family) with correspondingly uniformly designed connection interfaces for detachable connection to adjacent sub-assemblies of the base element module. In an embodiments the exchangeable cover element is plastic.

A modular cover element can be easily replaced by the end user. Reasons for replacing the cover element include, but are not limited to, cosmetic reasons due to scratches that frequently occur during operation of a bicycle derailleur due to its exposed position on the bicycle. The user thus has the option returning a rear derailleur to an almost-new appearance without having to replace the entire derailleur. This is desirable in terms of cost and resource consumption.

Another embodiment of the rear derailleur according to the present disclosure provides that the swivel formation module comprises two swivel arms in the manner of a shifting parallelogram for a translationally swiveling connection of the base element module and the shifting element module. Thereby, at least one of the swivel arms has at least one interchangeable swivel arm sub-assembly, which can be formed as a member of a swivel arm sub-assembly family.

In another embodiment, at least one replaceable swivel arm sub-assembly is a cover element protecting at least areas of the swivel formation module. In an embodiment, the cover element is plastic. Similar to the above with regard to the modularly replaceable covering element on the base element, a replaceable covering element protecting the shifting parallelogram not only protects the shifting parallelogram, but in particular makes it easy to repair the shifting parallelogram of the derailleur at low cost and with low resource consumption.

With regard to a further embodiment of the bicycle derailleur, it is provided that at least one swivel arm of the swivel formation module that connects the base element module and the shifting element module can be connected or is connected in a pivotable manner to the base element module and to the shifting element module by means of two link pins. Particularly, the cover element forms a locking element for the two link pins of the at least one swivel arm of the swivel formation module in such a way that the two link pins can be removed from the at least one swivel arm without tools when the cover element is removed.

In other words, this means that, for example, the outer parallelogram arm, which is frequently damaged or at least scratched during operation of a rear derailleur, being a one-piece sub-assembly according to the present disclosure, can be removed from the rear derailleur parallelogram, and can be repaired or replaced, without having to disassemble either the parallelogram module or the entire outer parallelogram arm, nor having to laboriously dismantle the link pins, as is usually the case with prior art rear derailleurs.

Rather, by simply removing the cover element (and in an embodiment without needing any special tools) the parallelogram pins basically fall out of the parallelogram module by gravity, and the parallelogram arm sub-assembly can be easily removed in one piece.

This contributes to the modular design and easy reparability of the rear derailleur according to the present disclosure, and thus makes it possible to implement the reduction in resource consumption requested by the consumer or required by legislative.

In another embodiment, at least one of the two parallelogram arms or swivel arms of the swivel formation module comprises at least two swivel arm sub-assemblies, of which at least one swivel arm sub-assembly is interchangeable and, in an embodiment, formed as a member of a swivel arm sub-assembly family. This embodiment enables the manufacturer to offer one or both sub-assemblies that make up the at least one parallelogram arm according to this embodiment, for example, in several variants to the consumer in order to be able to upgrade or redesign the appearance of their rear derailleur.

According to another embodiment of the rear derailleur, the shifting element module or the chain guiding device module comprises a spring/damper sub-assembly for springing and/or damping the pivoting movement of the chain guiding device module relative to the shifting element module. Particularly, the spring/damper sub-assembly is configured as a spring/damper unit that can be handled or replaced in one single piece, and that in an embodiment is a member of a shifting element or chain guiding device sub-assembly family, for example a shifting element of chain guiding device sub-assembly family containing various spring/damper sub-assemblies with various functions, various qualities or various target price points.

In this way, the rear derailleur spring/damper sub-assembly can be easily removed as a one-piece unit, repaired if necessary, or replaced with a different spring/damper sub-assembly, thus allowing the rear derailleur to be upgraded accordingly without the need to replace the entire derailleur.

In one embodiment, the spring/damper sub-assembly and a receptive housing of the shifting element module serving to receive the spring/damper sub-assembly are detachably connected to one another by means of an at least two-start thread pairing arranged on the spring/damper sub-assembly and on the receptive housing. Thereby and particularly, different screw threads of the multi-start thread pairing are axially and/or circumferentially unevenly spaced from each other with respect to the pivot axis of the chain guiding device, in such a way that the multi-start thread pairing is screwable into each other in only one rotational relative position.

This is advantageous because the spring/damper sub-assembly can thus be screwed into the receptive housing of the shifting element module in only one, namely the correct rotational relative position, although a multi-start thread usually has a number of different rotational screw-in start positions that corresponds to the number of threads.

In another embodiment, the chain guiding device module of the rear derailleur comprises at least one replaceable chain guiding device sub-assembly, which in an embodiments is configured as a member of a chain guiding device sub-assembly family, i.e., in particular is provided with connection interfaces that are uniform within the sub-assembly family for detachable connection to adjacent sub-assemblies, or modules, if applicable.

In another embodiment, the at least one replaceable sub-assembly of the chain guiding device module is a chain cage guide plate device, a chain guiding pulley, or a chain tensioning pulley.

This embodiment is also in the service of simple reparability and the reduction of resource consumption. In addition, different variants of the bicycle derailleur can again be provided for different price points, applications or target markets with relatively little effort. For example, one or both of the guide plates of the chain cage device can be provided and made from different materials, such as aluminum or carbon fiber, or chain guide rollers can be provided with different performance characteristics or features.

According to a further embodiment of the bicycle derailleur, it is provided that the bicycle derailleur is an electrically operated bicycle derailleur and comprises an electric module, wherein the electric module has at least one replaceable electric sub-assembly, which in an embodiment is formed as a member of an electric sub-assembly family. In an embodiment the at least one replaceable electric sub-assembly is an electric motor-gearbox sub-assembly or a battery unit.

The possibility of modular replacement, in particular of the electric motor-gear assembly in a bicycle derailleur, is again of service to the paradigm of simple reparability or interchangeability with low resource consumption. This makes sense, since the motor-gearbox sub-assembly of an electric bicycle circuit is a particularly complex and thus cost-intensive assembly.

Likewise, due to this embodiment of the derailleur according to the present disclosure, motor-gearbox sub-assemblies with different performance characteristics can be provided by the manufacturer, which either allows rear derailleurs for different target applications to be presented with little to manageable development effort, or allows the customer to upgrade their rear derailleur by installing, for example, a higher-quality motor-gearbox sub-assembly at a justifiable cost.

The present disclosure further relates to a motor-gearbox sub-assembly for a modular electric bicycle derailleur as described above, or generally for electrically operated bicycle derailleurs.

The motor-gearbox sub-assembly is characterized by the fact that a housing of the motor-gearbox sub-assembly can be connected to the base element module or B-knuckle with respect to its six spatial degrees of freedom of movement by means of exactly one rotational axis connection and exactly two translational stop connections. This design provides for easy positioning and assembly of the motor-gearbox sub-assembly in the base element of the rear derailleur. Further, the motor-gearbox sub-assembly this way is fixed in the base element without a possibility of under- or overdetermination of the positioning of the motor-gearbox sub-assembly in the base element in terms of dimensions or tolerances, since this embodiment fixes the motor-gearbox sub-assembly relative to the base element using no less than and no more than the exact six degrees of freedom that are required for any spatial fixation.

Further, the present disclosure relates to a motor-gearbox sub-assembly for a modular electric bicycle derailleur as described above, or generally for electrically operated bicycle derailleurs.

The motor-gearbox sub-assembly is characterized in that a housing of the motor-gearbox sub-assembly comprises at least two housing parts, for example housing halves. During the assembly or joining of the housing parts or housing halves, an electric motor of the motor-gearbox unit is fixed in the housing in a form-locking, play-free manner with respect to all six degrees of freedom of movement by means of a plug-in adapter, wherein the housing parts are configured to be spring-loading the plug-in adapter by this joining and the plug-in adapter remaining spring-loaded after the housing parts or housing halves have been joined.

The spring loading of the plug-in adapter, which is effected when the housing parts or housing halves are joined, can be effected by a separate spring, for example by a flexion spring. Alternatively, the resilient loading can also be effected by elastically yielding areas formed for example integrally with a housing half or with the plug-in adapter.

This way, the electric motor can be pre-assembled together with the plug-in adapter, whereby the final assembly of the electric motor requires no further steps other than the joining of the housing parts or housing halves with the unit of electric motor and plug-in adapter contained therein. This not only simplifies assembly and thus makes it less laborious and expensive, but also improves the reparability of the motor-gearbox sub-assembly. By comparison, in the prior art, corresponding adapters or brackets for motor mounting are often embedded inseparably in a housing component of the motor-gearbox sub-assembly, for example by overmolding, which makes both assembly and disassembly of the electric motor more difficult.

FIG. 1 shows a mountain bike with a prior art rear derailleur R_{D}. The mountain bike has a frame B_{F} with a suspended rear frame F_{R}. The drive train T_{D} of the mountain bike comprises a bottom bracket assembly A_{BB} with a bottom bracket shaft S_{BB}, a chainring R_{C}, a rear bicycle derailleur R_{D}, a sprocket cassette C_{S} with multiple sprockets and a drive chain C_{N}.

The bicycle rear derailleur R_{D} is connected to the rear frame F_{R} in the area of the right dropout or right frame eye D_{F} in a conventional manner. This means in particular that the base element of the rear derailleur R_{D} is connected to the right frame dropout D_{F} by means of a derailleur hanger H_{D} (cf. enlarged detailed illustration “A” in FIG. 1), which entails the disadvantages described in the introduction to the description, including in particular the low stability of the connection between the bicycle rear derailleur R_{D} and the rear frame F_{R}, and a poor shifting precision of the rear derailleur R_{D} due to this low stability and due to long and hardly controllable tolerance chains between the rear derailleur R_{D} and the sprocket cassette C_{S} running over the rear frame F_{R}and over the derailleur hanger H_{D}.

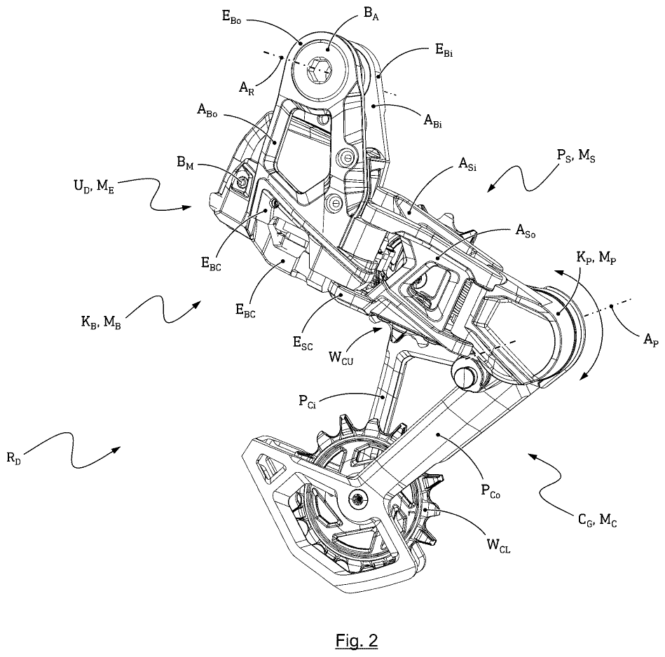

FIG. 2 shows an embodiment of a bicycle derailleur R_{D} according to the present disclosure in an oblique side view, enlarged with respect to FIG. 1. First of all, the general essential components of a bicycle derailleur R_{D} for a derailleur-based drivetrain can be seen, namely a base element K_{B}, also known in the industry as B-knuckle, which serves to fasten the bicycle derailleur R_{D} to the right frame dropout D_{F} of the rear frame F_{R}, furthermore a shifting element K_{P}, also known in the industry as P-knuckle, which, for the purpose of gear selection, is connected in a translationally pivotable manner to the base element K_{B} via an pivoting arrangement P_{S} also known as a shifting parallelogram P_{S}, and furthermore a chain guiding device C_{G} also known as a chain cage or chain cage arrangement with an upper chain guide pulley W_{CU} and with a lower chain tensioning pulley W_{CL}.

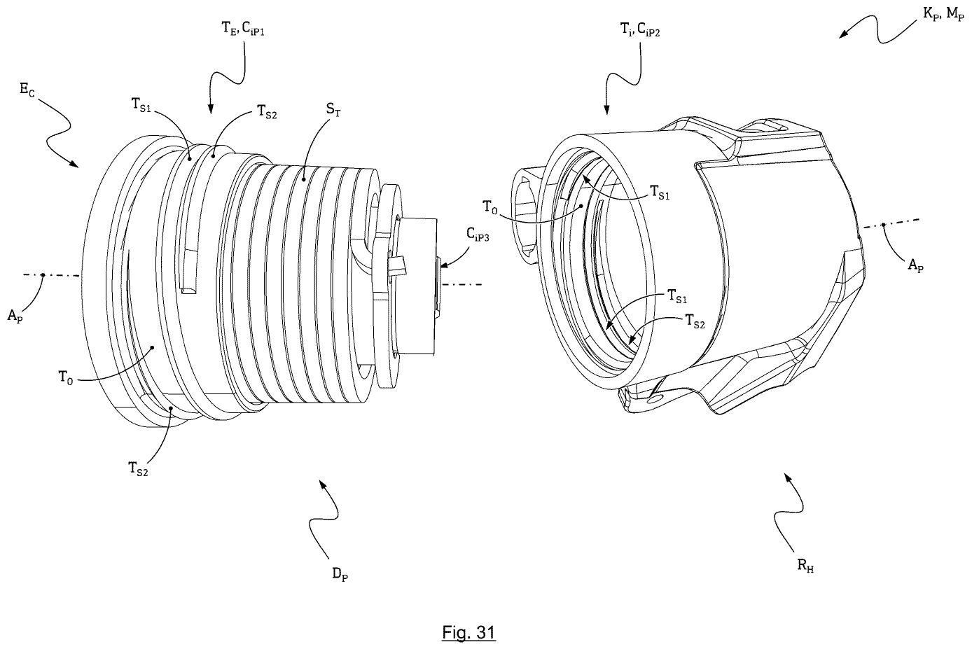

The chain guiding device C_{G} comprises inner and outer chain cage guide plate devices P_{Ci}, P_{Co} and is pivotable about a chain cage pivot axis A_{P} relative to the shifting element K_{P}, and is under a spring bias acting clockwise about this pivot axis A_{P}, which bias provides for the bias of the idle run of the bicycle chain C_{N} according to FIG. 1, cf. spring element or cage spring S_{T} of the spring/damper device D_{P} according to FIG. 31.

FIG. 2 also shows the outer swivel arm A_{So} and the inner swivel arm A_{Si} of the swivel formation P_{S}, whereby the outer swivel arm A_{So} is provided with a cover element E_{SC} which protects against damage such as scratches and is made of plastic, for example. In this embodiment, further cover elements E_{BC} arranged in the lower region of the base element K_{B} serve a similar purpose.

The rear derailleur R_{D} according to FIG. 2 is an electromechanical, in particular wirelessly controllable rear derailleur, and comprises an electric drive unit U_{D}, which will be discussed and shown in more detail further below.

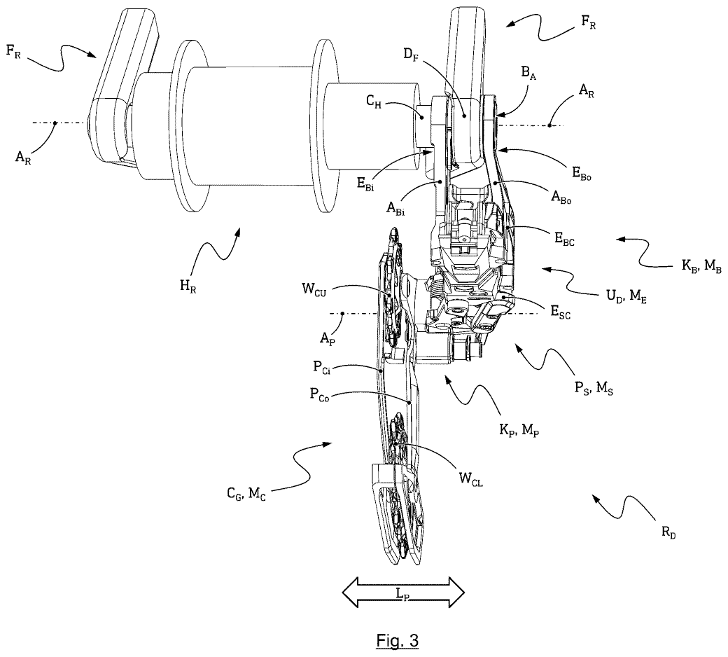

The bicycle rear derailleur R_{D} shown in FIG. 2 is a rear derailleur R_{D} for coaxial direct mounting in relation to the rear wheel axis A_{R}, which can be seen particularly clearly in FIG. 3. The decisive advantages of rear derailleurs that can be mounted coaxially directly in relation to the rear wheel axis A_{R}, including in particular the massively improved stability of the connection to the rear frame F_{R} and an order of magnitude improvement in the precision of the positioning of the rear derailleur R_{D} compared to the sprocket cassette C_{S}, is discussed in detail in the introduction to the description.

As can be seen in FIG. 2 and in particular in FIG. 3, the base element K_{B} of the bicycle derailleur R_{D} comprises, for the purpose of rear axle coaxial mounting, an inner mounting arm A_{Bi} with an inner pivot joint, here in the form of a pivot eye E_{Bi} and an outer mounting arm A_{Bo} with an outer pivot joint, here in the form of a pivot eye E_{Bo}. The inner mounting arm A_{Bi} is used for inboard positioning in the area of the right frame dropout D_{F} of the rear frame F_{R} , and the outer mounting arm A_{Bo} is used for outboard positioning in the area of the frame dropout D_{F}. The rear derailleur R_{D} can be connected to the right frame dropout D_{F} of the rear frame F_{R} via the inner pivot eye E_{Bi} of the inner mounting arm A_{Bi} and via the outer pivot eye E_{Bo} of the outer mounting arm A_{Bo} coaxial to the rear wheel axis A_{R}, for which purpose an adapter bolt device B_{A} is used.

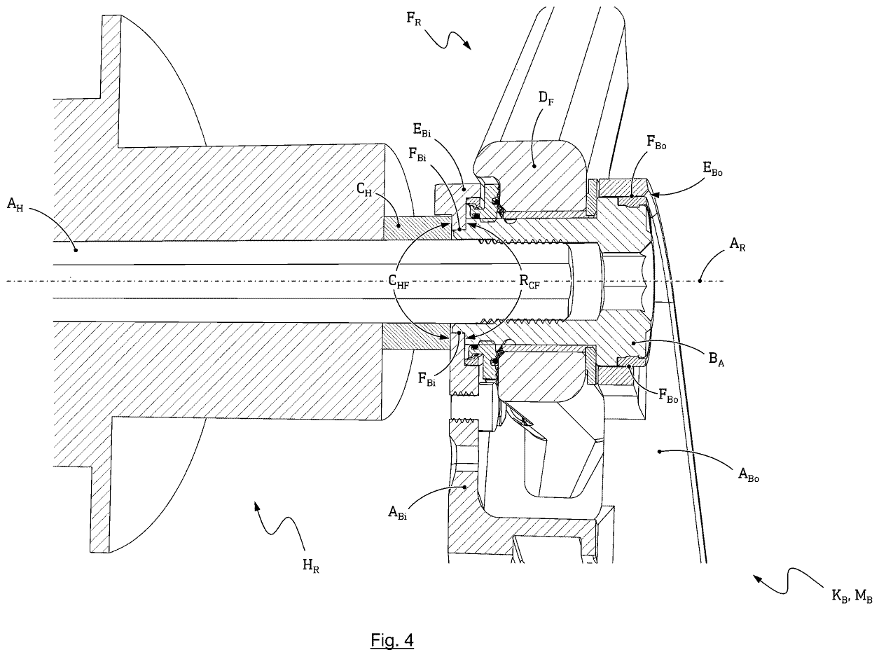

The rear derailleur R_{D} is mounted on the frame dropout D_{F} by means of an adapter bolt device B_{A} in such a way that, in particular after insertion and clamping of the hub axle A_{H} of the rear hub H_{R}, a defined fixed/loose mounting of the two mounting arms A_{Bi} and A_{Bo} of the base element K_{B} is achieved. A schematic axial section through frame dropout D_{F}, rear hub H_{R} and base element K_{B} of a two-arm coaxially mounted bicycle derailleur R_{D} according to FIGS. 2 and 3 with such a fixed/loose bearing arrangement is shown in FIG. 4.

In the illustration of FIG. 4, the hub axle A_{H} is screwed into the adapter bolt device B_{A} and axially clamped to the adapter bolt device B_{A} via the hub end cap face C_{H}. It can be seen that the two mounting arms A_{Bi} and A_{Bo} of the base element K_{B} are fixed in the radial direction with practically no play and coaxially to the rear wheel axis A_{R} by the fact that the pivot eyes E_{Bi} and E_{Bo} of the mounting arms A_{Bi} and A_{Bo} are slidingly mounted on corresponding, here essentially cylindrical bearing faces F_{Bi}, F_{Bo} of the adapter bolt device B_{A}.

In particular, FIG. 4 shows how the inboard or left-hand fastening arm A_{Bi} is clamped in the axial direction when the hub axle A_{H} is tightened, i.e. when the hub end cap C_{H} is clamped axially between the right-hand end face CHF of the hub end cap shown only schematically here and a circumferential recess R_{CF} of the adapter bolt device B_{A}, and thus assumes the role of the fixed bearing of the base element K_{B} and thus of the rear derailleur in the axial direction of the rear wheel axis A_{R}, while the outboard or right-hand side mounting arm A_{Bo} is not fixed in the axial direction at F_{Bo} and thus forms the floating bearing of the base element K_{B} and thus of the rear derailleur with respect to the axial direction of the rear wheel axis A_{R}.

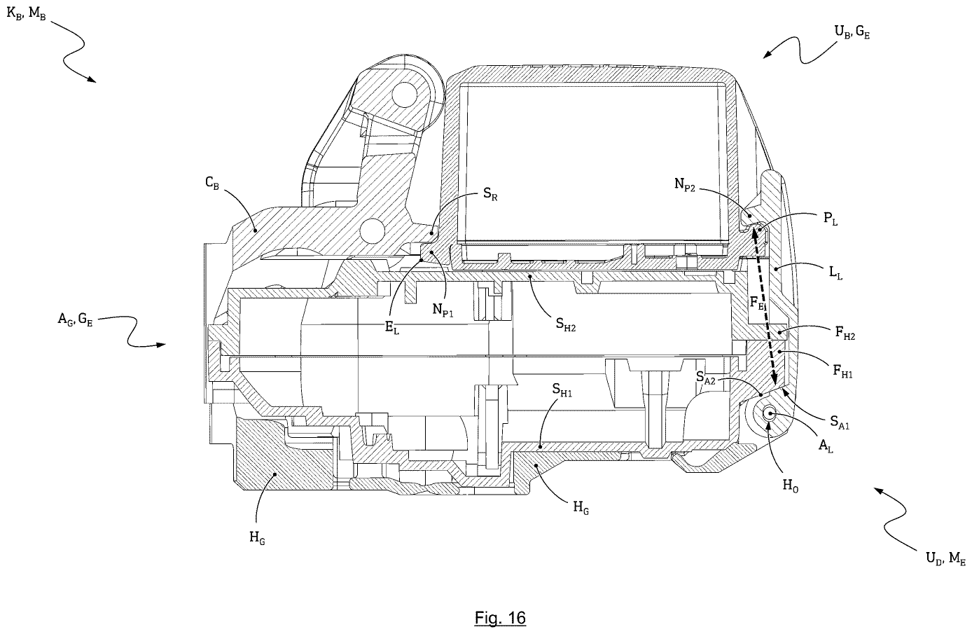

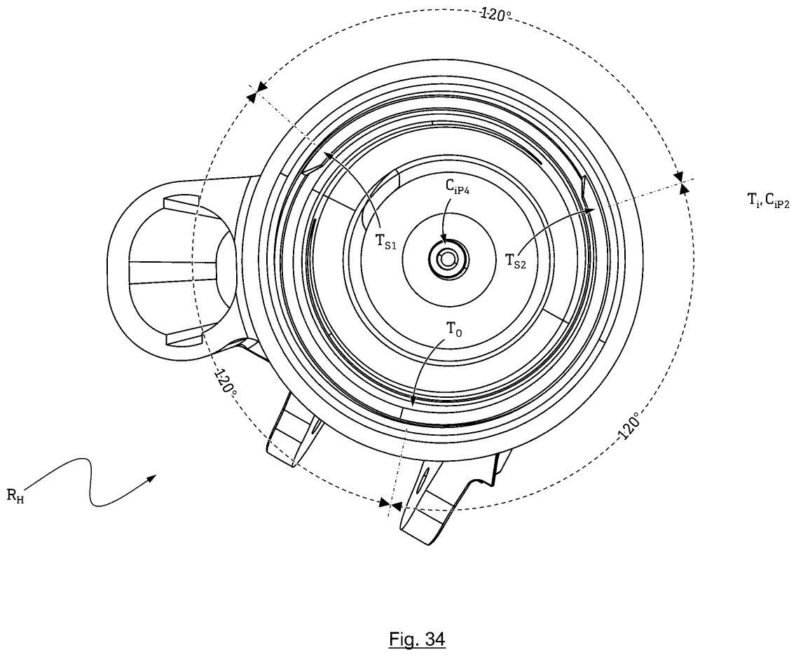

The resulting power flow of such a two-armed, coaxially mountable rear derailleur R_{D} is shown in more detail in the German patent application DE102020132208.9 in FIG. 34 and the associated description, in the European patent application EP3388324A2 in paragraph [0082] and the associated FIG. 16, and in U.S. Pat. No. 10,870,464 B2 in Col. 19 Para. 2 and FIG. 16.

From this and from FIGS. 2 to 4, it can be seen that this two-arm and two-sided mounting or attachment of the rear derailleur R_{D} is up to orders of magnitude more stable and more resistant to bending, or can be designed to be so, than the previously common one-sided attachment of bicycle derailleurs by means of a derailleur hanger, see FIG. 1 as well as the detailed description of the disadvantages of the rear derailleur attachment with a derailleur hanger in the introduction to the description.

Furthermore, it can be seen in particular from FIG. 4 that the position of the base element K_{B} and thus of the rear derailleur R_{D}, is exactly fixed both in the radial direction, relative to the rear wheel axis A_{R}, and in particular also in the axial direction, relative to the hub end cap C_{H}, due to the two-arm fixed/floating bearing C_{HF}, R_{CF}, F_{Bi}, F_{Bo}.

However, since the position of the sprocket cassette C_{S} (not shown in FIG. 4, cf. FIG. 1) is also fixed exactly in the radial direction with respect to the rear wheel axis A_{R} and usually also in the axial direction with respect to the hub end cap end face C_{H}, this two-arm fixed/floating bearing C_{HF}, R_{CF}, F_{Bi}, F_{Bo} of the bicycle rear derailleur R_{D} directly in the area of the frame dropout D_{F} and directly in relation to the rear wheel axis A_{R} and hub end cap C_{H} leads to an extremely short tolerance chain between the position and location of the bicycle derailleur R_{D} and the position and location of the sprocket cassette C_{S}.

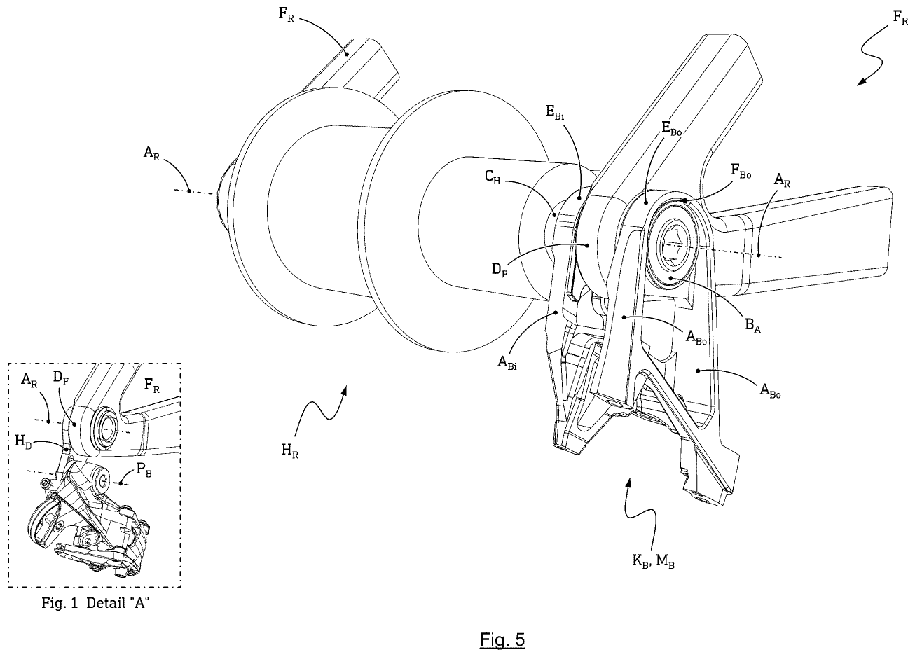

FIG. 5 shows the rear frame F_{R} and the rear hub H_{R} as well as the bicycle derailleur base element K_{B} according to FIGS. 2 to 4 of the bicycle derailleur R_{D} according to FIGS. 2 and 3 once again in perspective oblique view from outboard.

In comparison to the conventional derailleur hanger (see detail “A” of FIG. 1 with derailleur hanger H_{D} and the detailed description of the disadvantages of fastening the rear derailleur by means of derailleur hanger H_{D} in the introduction to the description), it can be seen how the two-armed, particularly rigid fastening of the bicycle rear derailleur R_{D} as well as the shortened, direct tolerance chain between rear derailleur R_{D} and sprocket cassette C_{S}, as described above with reference to FIG. 4, contributes to decisive improvements in shifting performance and shifting precision of the bicycle derailleur R_{D} which is coaxially referenced to the rear wheel axis A_{R} and connected on both sides of the frame dropout D_{F}.

This improved performance and precision is also maintained permanently because the rigid two-arm attachment A_{Bi}, A_{Bo} of the bicycle rear derailleur R_{D} does not deform even under high load, which is otherwise common with traditional derailleur hangers H_{D}.

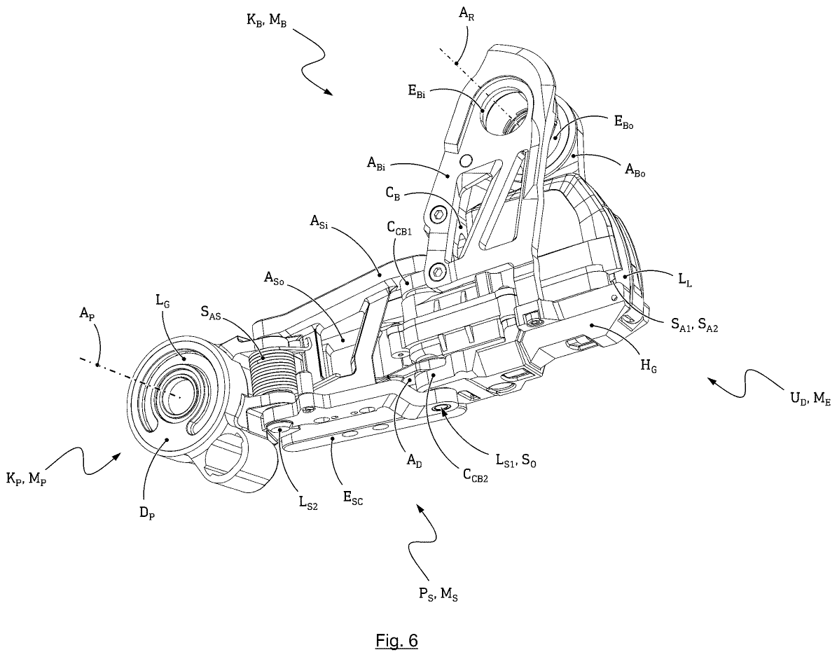

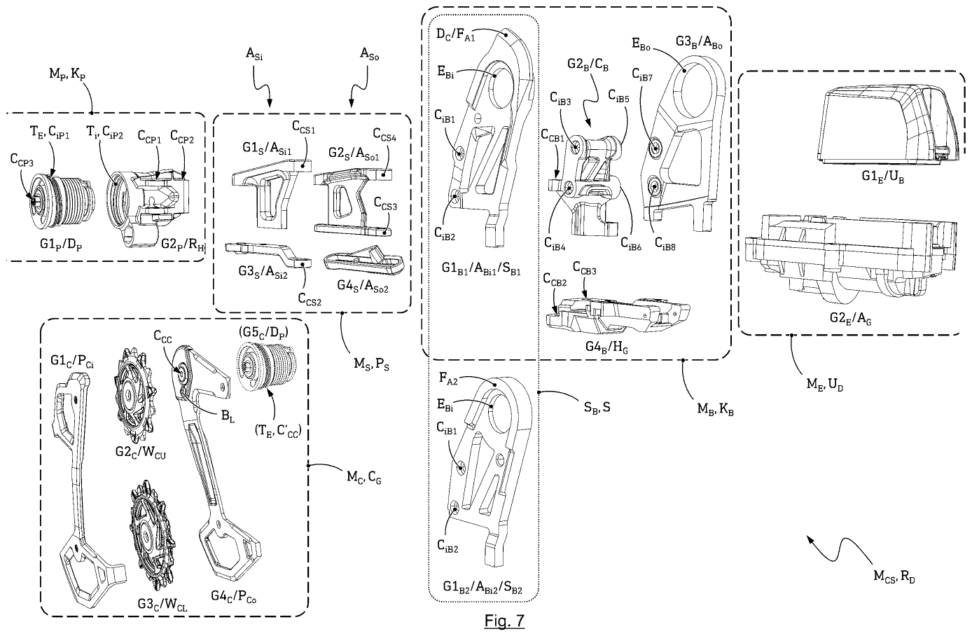

FIG. 6 shows the body of the bicycle rear derailleur R_{D} according to FIGS. 2 and 3 in an oblique perspective side view from inboard, with a view of the inside of the rear derailleur and the underside of the rear derailleur. Essential components of the rear derailleur are again shown, including the base element K_{B} with inner and outer mounting arms A_{Bi}, A_{Bo} and with inner and outer mounting eyes E_{Bi} and E_{Bo}, respectively, as well as the electric motor drive unit U_{D}, rear derailleur parallelogram and rear derailleur bottom side, respectively. swivel formation P_{S} with inner swivel arm A_{Si}, link pins L_{S1} and L_{S2}, outer swivel arm A_{So} and swivel arm cover element E_{SC}, and with P-knuckle or shifting element K_{P} and a spring/damper sub-assembly D_{P} arranged therein (cf. FIGS. 7 and 31).

FIG. 7 shows the bicycle rear derailleur R_{D} according to FIGS. 2, 3 and 6 in a perspective exploded view, whereby FIG. 7 particularly also visualizes an embodiment of the modular rear derailleur construction system M_{CS} according to the present disclosure. For the sake of clarity, various connecting elements such as screws, pins, bolts, bearing sleeves, shafts, etc. are omitted in the illustration of FIG. 7.

In FIG. 7, it can be seen that the bicycle rear derailleur R_{D} according to the modular construction system M_{CS} is composed of a number of modules M, each of which is outlined with a thick dashed line in FIG. 7. The design of the rear derailleur modular system M_{CS} shown in FIG. 7 comprises the modules “base element module M_{B}”, “swivel formation module M_{S}”, “shifting element module M_{P}”, “chain guiding device module M_{C}” and “electric module M_{E}”.

Each of the modules M_{B}, M_{S}, M_{P}, M_{C} and M_{E} contains at least one sub-assembly G. In the example shown, each of the five modules M_{B}, M_{S}, M_{P}, M_{C} and M_{E} contains at least two sub-assemblies G each.

At least one sub-assembly G of at least one of the modules M_{B}, M_{S}, M_{P}, M_{C} and M_{E} is a family member S₁-Sₙ, for example the sub-assembly A_{Bi} of the base element module M_{B} family member S_{B1}-S_{Bn} of a family S_{B} of sub-assemblies G_{B} comprising at least two family members S_{B1}, S_{B2}. Taking the example of the inboard-side mounting arm A_{Bi} within the base element module M_{B}, in the embodiment under consideration there is a sub-assembly family S_{B} comprising two inboard-side mounting arms A_{Bi1} and A_{Bi2}. In this case, the sub-assembly family S_{B} comprises the two sub-assemblies G1_{B1} and G1_{B2} (variant B1 and variant B2 of the first sub-assembly G1 of the base element module M_{B}), which thus represent sub-assembly family members S_{B1} and S_{B2}, which in this case are two differently formed inboard-side mounting arms A_{Bi}.

In the embodiment shown, the two family members S_{B1} and S_{B2}, i.e. the two interchangeable mounting arms A_{Bi1} and A_{Bi2} on the inboard side of the base element module M_{B}, which each form one of the sub-assemblies G_{B} of the base element module M_{B}, are made of different materials, for example, or have a different design, or have different sub-assembly features F_{A1}, F_{A2}. In this case, for example, the two interchangeable mounting arms A_{Bi1} and A_{Bi2} have a different design in the region above the pivot eye E_{Bi} either with an additional chain deflector D_{C} (see family member/mounting arm A_{Bi1}), or without additional chain deflector (see family member/mounting arm A_{Bi2}).

Thereby, for the at least one sub-assembly family S_{B} (in case of several sub-assembly families S within the modular system M_{CS} for each sub-assembly family S of the modular system M_{CS}) detachable connection interfaces Cᵢ of the sub-assembly family members S_{Xn}, S_{Xm} (in the present example of a sub-assembly G_{B} of the base element module M_{B}, thus, for example, the family members S_{B1} and S_{B2}) to adjacent sub-assemblies G of the at least one module M (as well as, insofar as present at the respective sub-assembly G, connection interfaces C_{C} to adjacent modules M) within the at least one sub-assembly family S_{B} are configured uniformly across all family members S_{Xn}, S_{Xm} in such a way that a family member S_{Xn} of the at least one sub-assembly family S_{B} of the at least one module M, while retaining the remaining sub-assemblies G of the at least one module M, is interchangeable for another family member S_{Xm} of the same sub-assembly family S_{B}, but of different materials, of different design, with different functionalities, or with different surface properties.

Further referring to FIG. 7 and again using the example of an sub-assembly G_{B} of the base element module M_{B}, specifically using the example of the sub-assembly G_{1B} (inboard-side mounting arm A_{Bi}), this means that for the mounting arm sub-assembly family S_{B} detachable connection interfaces C_{iB1}, C_{iB2} of the sub-assembly family members S_{B1}, S_{B2}, i.e. of the two mutually interchangeable inboard side mounting arms A_{Bi1} and A_{Bi2} to the adjacent sub-assembly G_{2B} of the base element module M_{B}, in this case to the connecting bracket C_{B}, the sub-assembly family members S_{B1} and S_{B2} are configured uniformly in such a way that the family member S_{B1} of the sub-assembly family S_{B} of the base element module M_{B}, in the example considered the mounting arm A_{Bi1} on the inboard side, while retaining the other sub-assemblies G_{B} of the base element module M_{B}, in this case thus retaining the connecting bracket G2_{B}/C_{B}, the outboard mounting arm G3_{B}/A_{Bo} and the gearbox holder G4_{B}/H_{G}, are interchangeable with another family member of the same sub-assembly family S_{B}, but of a different material, of a different design, of a different design, of a different functionality or of a different surface property, in this case, for example, for the family member S_{B2} of the sub-assembly family S_{B} of the base element module M_{B}, which, in the present embodiment of the modular system M_{CS}, has a different design and, in the region above the pivot eye E_{Bi}, has a different feature F_{A2} than the family member S_{B1}.

If, for example, the connecting bracket C_{B} is considered, which, within the base element module M_{B}, particularly connects the inboard mounting arm A_{Bi}, the outboard mounting arm A_{Bo} and the gearbox holder H_{G} (cf. FIGS. 6 to 9), it can be seen that the connecting bracket C_{B}, in addition to the detachable connection interfaces C_{iB3}, C_{iB4}, C_{iB5}, C_{iB6} to the respective adjacent sub-assemblies G_{B} within the base element module M_{B}, also has connection interfaces C_{C} to the adjacent swivel arm sub-assembly M_{S}, visible in FIG. 7, in particular the connection interface C_{CB1} for connection to a corresponding, shape-corresponding interface C_{CS4} of the swivel arm A_{So} in the adjacent swivel formation module.

These connection interfaces C_{C} to adjacent swivel formation modules M are also designed in such a way that a respective family member, here the sub-assembly C_{B}, i.e. the connecting bracket C_{B}, within a family S_{B} comprising at least two family members S_{B1}, S_{B2} of connecting bracket sub-assemblies C_{B}/G_{B} of the base element module M_{B}, while retaining the remaining sub-assemblies G_{B} of the base element module M_{B}, in this case while retaining the gearbox holder sub-assembly G_{B}/H_{G}, the inboard mounting arm sub-assembly G_{B}/A_{Bi} and the outboard mounting arm sub-assembly G_{B}/A_{Bo}, for another family member of the same sub-assembly family S, but made of a different material, of a different shape, of a different functionality or of a different surface property.

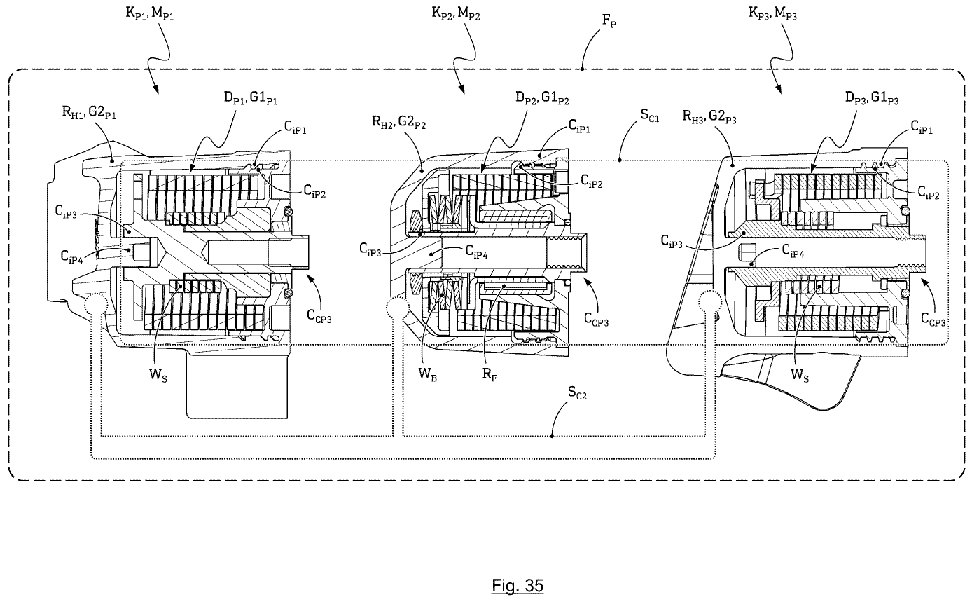

Analogously and alternatively, or in addition to the presence of sub-assembly families S_{B} within modules M, the modular construction system M_{CS} or the rear derailleur R_{D} can also be set up to use at least one module family F comprising at least two family members M of modules M within the rear derailleur R_{D}. For this purpose, detachable connection interfaces C_{C} of the family members M to respective adjacent modules M of the rear derailleur R_{D} are provided for the at least one module family F, in the case of a plurality of module families for each module family, within the at least one module family F, the connection interfaces C_{C} being configured uniformly across all family members in such a way that a family member M of the at least one module family F, for example a base element module M_{B}, a swivel formation module M_{S}, a shifting element module M_{P} or a chain guiding device module MC, e.g. a first base element module family member M_{B1}, while retaining the remaining modules M of the rear derailleur R_{D}, is exchangeable for another family member M of the same module family F, e.g., for a second base element module family member M_{B2} with different properties, for example of different materials, of different design, of different functionality or of different surface properties. An example of this is shown in FIG. 35 and described further below in the associated figure description of FIG. 35.

This exchange of a family member for another family member of a sub-assembly G or a module M can, for example, already be provided for by the manufacturer during production planning, whereby a large number of different variants or quality levels of the rear derailleur R_{D} can be more easily planned and produced by the manufacturer.

Due to the definition and configuration of uniform and easily detachable connection interfaces across all family members in the modular construction system M_{CS} according to the present disclosure, this exchange of sub-assemblies G or modules M can also be carried out by members of the bicycle trade, by specialist workshops, or even by the end-user, with little effort.

This way, it is also possible to meet the increasing demands of society and legislature for improvements to the reparability of technical goods.

In this context, sub-assembly families S or module families F of the modular bicycle derailleur construction system M_{CS} can also be designed in such a way that they can be replaced by the end user even without specialist tools or with standard household tools. This way it is possible for the customer or end user to repair their bicycle derailleur R_{D} with little effort, or to renew worn parts, in order to increase the useful life of the bicycle derailleur R_{D} with reduced costs and reduced resource consumption.

It also becomes possible for the end user to exchange family members, i.e. sub-assemblies G or modules S of the bicycle rear derailleur, for corresponding different sub-assemblies G or modules S of the same sub-assembly or module family, in particular of higher quality or with additional features, in order to achieve a higher-quality product at comparatively low cost without having to purchase a complete new rear derailleur R_{D}.

In the embodiment of the modular system M_{CS} shown in FIG. 7, the P-knuckle or shifting element module M_{P} can comprise a spring/damper device D_{P} as shown for springing and vibration-damping pretensioning of the chain by means of the chain guiding device C_{G}. The spring/damper device D_{P} then provides a connection interface C_{CP3} across family members for connection to a corresponding, shape-corresponding and likewise cross-family member interface C_{CC} of the outer chain cage guide plate device P_{Co} in the adjacent chain guiding device module M_{C}.

Alternatively, the spring/damper device D_{P} can also be assigned to the chain guiding device module M_{C}, which is visualized in FIG. 7 by a spring/damper device D_{P} arranged within the chain guiding device module M_{C}, drawn with dashes and provided with bracketed reference signs. In this case, the external thread T_{E} of the receptive housing R_{H} of the shifting element K_{P} then forms a connection interface C′_{CC} across family members for connection to a corresponding interface Tᵢ, C_{iP2} of the receptive housing R_{H} in the adjacent shifting element module M_{P}, which corresponds in shape and is also across family members.

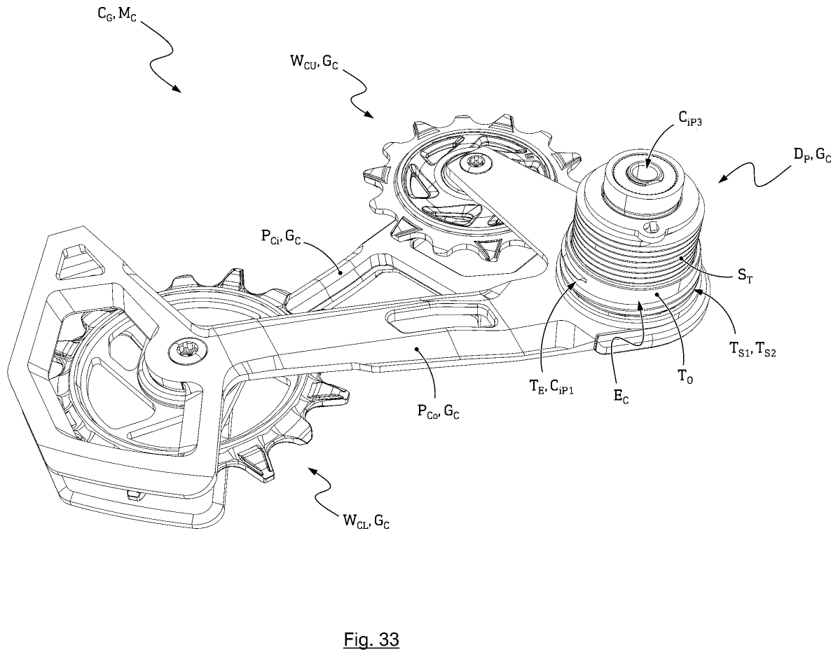

The background of a spring/damper device D_{P} associated with the chain guiding device module M_{C} is explained in more detail below with reference to FIGS. 33 and 34.

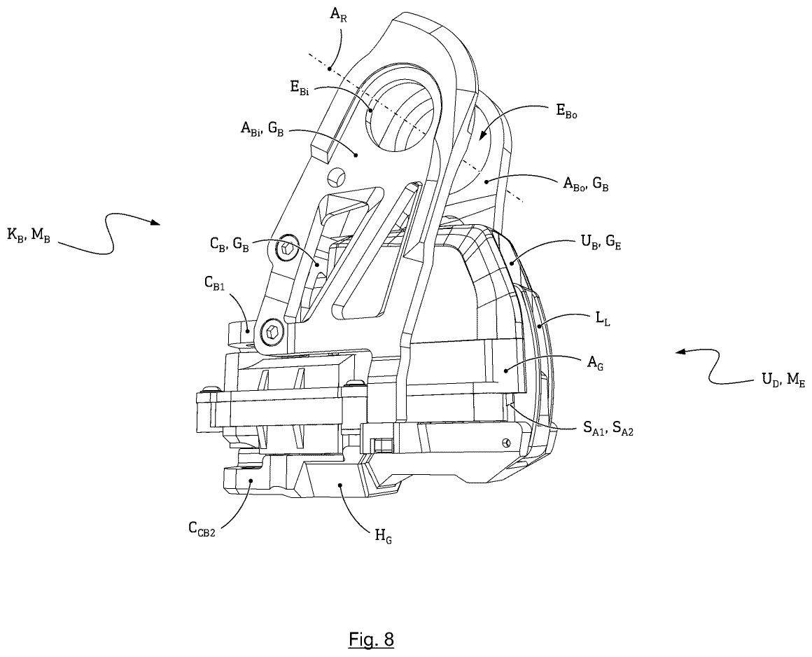

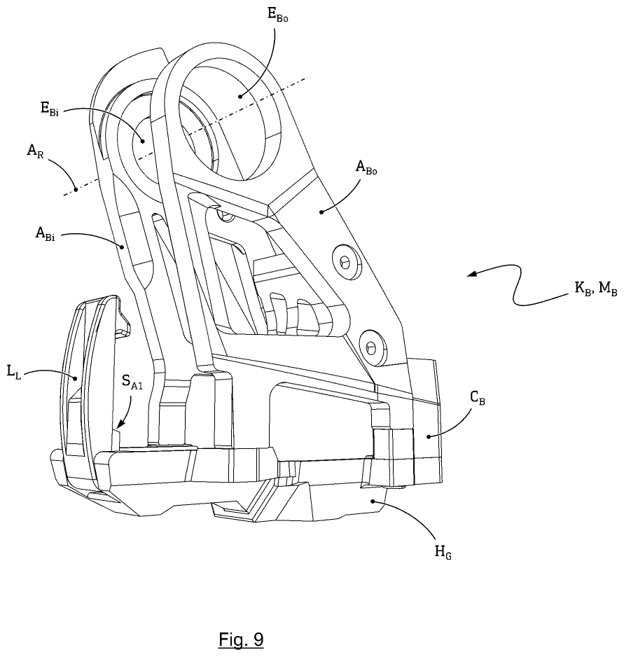

FIG. 8 and FIG. 9 show the base element or B-knuckle K_{B} of the rear derailleur R_{D} according to FIGS. 2 and 3 in views from diagonally inboard and diagonally outboard, respectively. In particular, the two-armed mounting with the mounting arms A_{Bi}, A_{Bo} and the pivot eyes E_{Bi}, E_{Bo} for coaxial mounting of the rear derailleur with respect to the rear wheel axis A_{R} can be seen again. FIG. 8 additionally shows an electric drive unit U_{D} of the bicycle rear derailleur R_{D}, comprising in particular a motor-gearbox sub-assembly A_{G} as well as a replaceable battery unit U_{B} held by a latching lever L_{L}, which is described in more detail below.

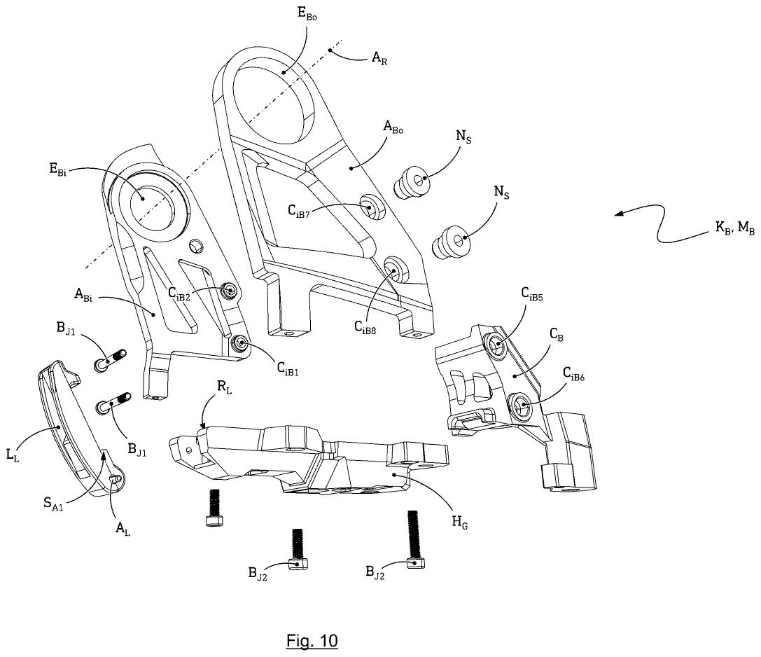

FIG. 10 shows the base element or B-knuckle K_{B} of the rear derailleur R_{D} according to FIGS. 2 and 3 in a view identical to FIG. 9, but in exploded view. Here, too, the two-arm design of the base element K_{B} with mounting arms A_{Bi}, A_{Bo} and pivot eyes E_{Bi}, E_{Bo} for coaxial mounting of the rear derailleur R_{D} on the frame dropout D_{F} of the rear frame in relation to the rear wheel axis A_{R} can be seen.

As shown in FIG. 10, the base element or B-knuckle K_{B} is divided into the two mounting arms A_{Bi}, A_{Bo}, a gearbox holder H_{G}, a connecting bracket C_{B} and a latching lever LL for securing the battery or the exchangeable battery U_{B} (see FIG. 8). It can be seen that for simple replacement of, for example, the outer mounting arm A_{Bo}, only the two screw nuts N_{S} of the joining bolts B_{J1} and the two further joining bolts B_{J2} need to be loosened. The same applies analogously to the inner mounting arm A_{Bi}, to the gearbox holder HG with the battery latching lever L_{L} pivotably attached to it, and to the connecting bracket C_{B}. All these parts of the base element K_{B} are thus easily replaceable, which contributes to the desired comprehensive serviceability and repairability of the bicycle derailleur R_{D}.

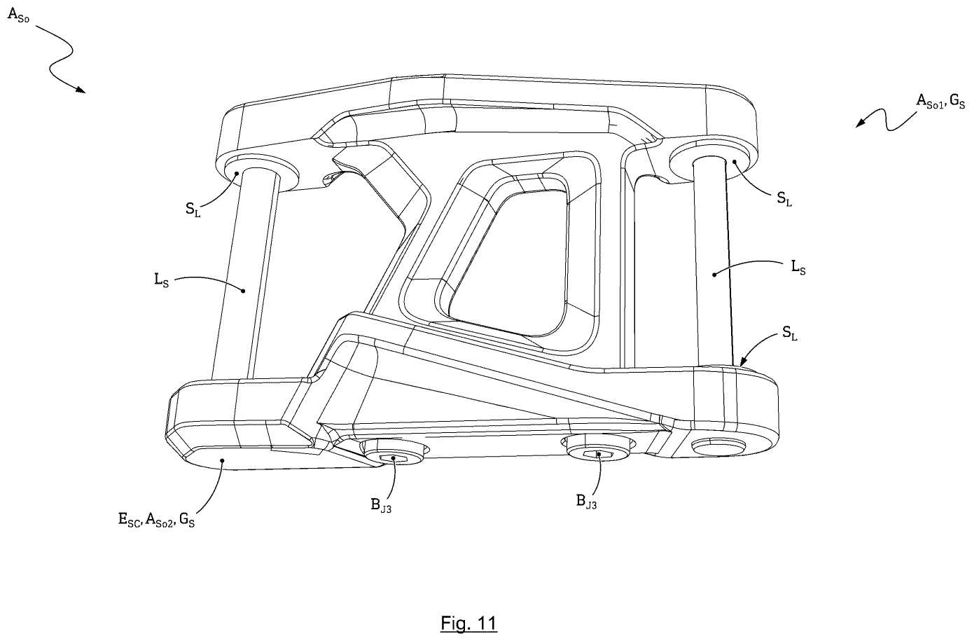

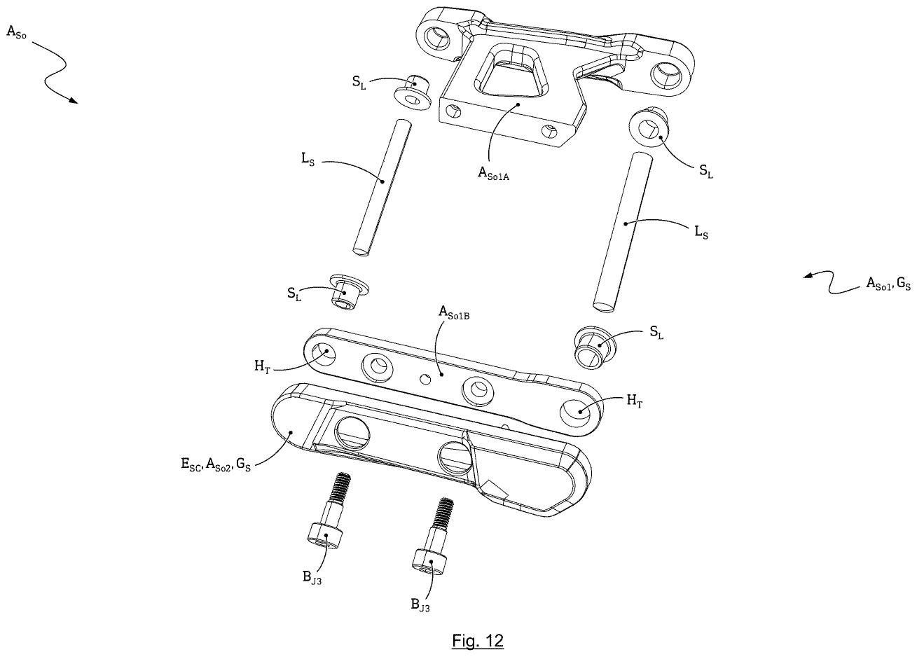

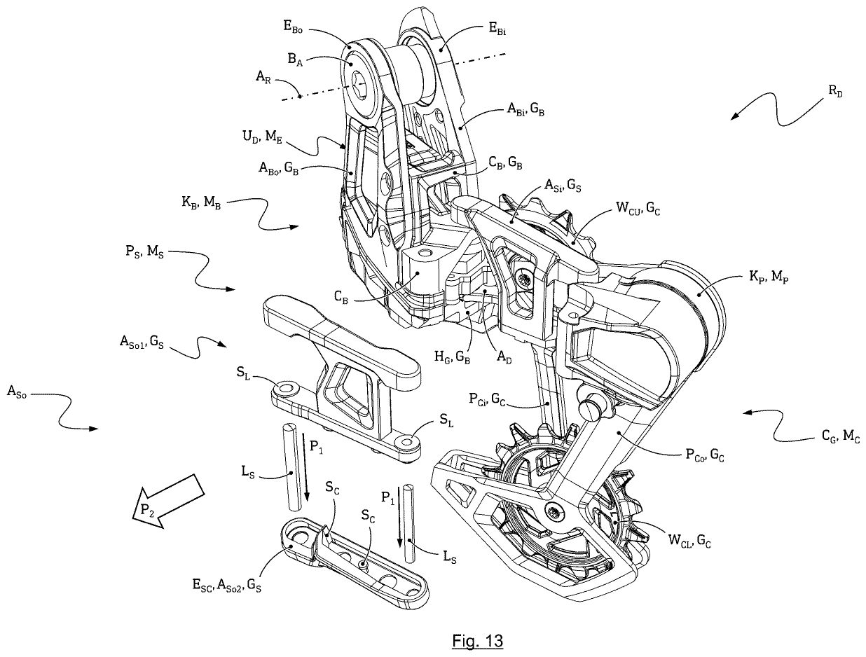

FIGS. 11 to 13 show an outer parallelogram arm or swivel arm A_{So} of the rear derailleur R_{D} according to FIGS. 2, 3, 6 and 13, in each case with the direction of view from outboard, whereby FIGS. 12 and 13 show the parallelogram arm or swivel arm A_{So} according to FIG. 11 in disassembled form. First of all, it can be seen that the outboard-side swivel arm A_{So} comprises, in particular, the swivel arm sub-assemblies A_{So1} and A_{So2} as well as link pins L_{S} accommodated in bearing sleeves S_{L}. In this case, the swivel arm sub-assembly A_{So1} breaks down into further individual parts such as A_{So1A}, A_{So1B}, S_{L}, L_{S}, which are connected, i.e. bolted together, by means of two joining bolts B_{J3}.

The swivel arm sub-assembly A_{So2} is here in the form of a cover element E_{SC} protecting the parallelogram arm or swivel arm A_{So}, which can be connected to the swivel arm sub-assembly A_{So1} by means of undercuts or snap connections S_{C} shown in FIG. 13.

In the embodiment example of the modular multi-part outer swivel arm A_{So} shown in FIGS. 11 to 13, the cover element E_{SC} realizes an additional function.

As can be seen in particular from FIG. 13, this additional function of the swivel arm sub-assembly A_{So2}, or of the cover element E_{SC}, consists in the fact that after removing only the swivel arm cover element E_{SC}, without further disassembly of the swivel arm A_{So}, in particular without loosening the joining bolts B_{J3}, the link pins L_{S} can be removed directly from the swivel arm A_{So} downwards along the direction of the arrows P₁. Thereupon, the complete swivel arm A_{So} can thus be removed from the rear derailleur R_{D} without tools, as shown in FIG. 13 by means of the block arrow P₂, and thus easily repaired or replaced, for example. Only individual parts of the swivel arm A_{So}, such as axles, bearing sleeves or the swivel arm cover element E_{SC}, can also be easily replaced in this way.

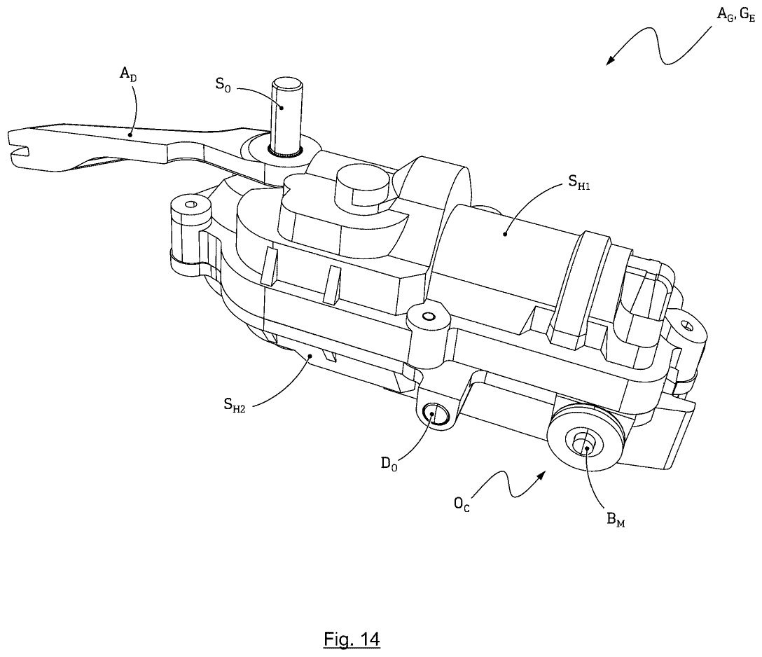

FIGS. 14 to 25 show the motor-gearbox sub-assembly A_{G} of the rear derailleur R_{D} already mentioned above with reference to FIGS. 6 to 8 in various views and sectional views according to FIGS. 2, 3 and 6 to 8.

FIG. 14 shows the motor-gearbox sub-assembly A_{G} in an oblique perspective view from outboard. Due to the illustration with a view of the underside of the motor-gearbox sub-assembly A_{G}, FIG. 14 shows the motor-gearbox sub-assembly A_{G} upside down, relative to the illustration in FIGS. 2, 3 and 6 to 8. In particular, FIG. 14 shows an output shaft S_{O}, which in the illustration in FIG. 6 coincides or corresponds with the link pin L_{S1} shown there.

Pressed onto a knurled section of the output shaft S_{O} is a drive arm A_{D}, which is used to transmit the shifting forces from the motor-gearbox sub-assembly A_{G} to the rear derailleur R_{D}, see also FIGS. 6 and 13, for example.

FIG. 14 also shows an operating control O_{C} comprising a button B_{M}, which is used for the selection of certain operating modes of the electric derailleur R_{D} by the user, as well as an operating display in the form of a light-emitting diode D_{O}, which signals certain operating states of the electric rear derailleur R_{D} to the user.

In addition, it can be seen in FIG. 14 that the motor-gearbox sub-assembly A_{G} is designed to be particularly space-saving in that the housing halves or housing sections S_{H1}, S_{H2} are designed to fit as closely as possible to the inner parts of the motor-gearbox sub-assembly A_{G}, as can be seen, for example, from the shape of the upper housing half S_{H1}, which in the right-hand area of the drawing reproduces the shape of the electric motor EM contained therein (cf. FIGS. 16, 20 and 22) and in the drawing-related left-hand area closely follows the shapes of the gear parts contained in this area (cf. FIGS. 16, 22 and 23).

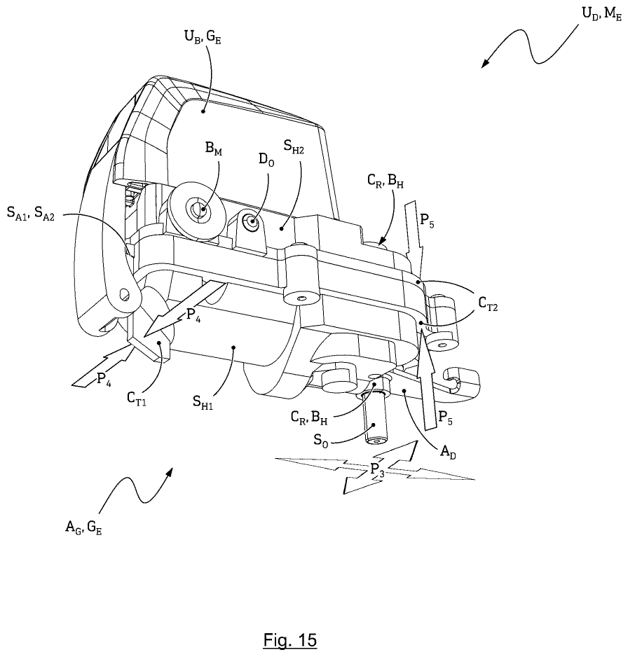

FIG. 15 shows a motor-gearbox sub-assembly A_{G} similar to the one shown in FIG. 14, with inserted exchangeable battery UB in an oblique perspective view from outboard. The motor-gearbox sub-assembly A_{G} differs from the motor-gearbox sub-assembly A_{G} shown in FIG. 14 only by a structurally different drive arm A_{D}, which in the embodiment according to FIG. 15 is designed as a stamped and bent part, while the drive arm A_{D} in the embodiment according to FIG. 14 can be designed, for example, as a milled part or injection molded part.

The block arrow groups P₃, P₄ and P₅ in FIG. 15 indicate how the motor-gearbox sub-assembly A_{G} is fixed and secured in the B-knuckle or base element K_{B} with respect to all six spatial degrees of freedom of movement without any geometric under- or overdetermination. This is done by means of a rotational axis connection C_{R}, the spatial fixation of which, for the motor-gearbox sub-assembly A_{G}, is visualized in FIG. 15 by the group of block arrows P₃, which can be realized, for example, by means of two housing beads B_{H} arranged coaxially around the output shaft S_{O}, and of which one or both are fixed during assembly of the motor-gearbox sub-assembly A_{G} in the base element K_{B}, e.g. in correspondingly shaped recesses of the gearbox holder H_{G} and the connecting bracket C_{B} of the base element K_{B} (cf. FIGS. 6 and 8), and furthermore by means of two translational stop connections C_{T1} and C_{T2}, whose force transmission and translational fixing of the motor-gearbox sub-assembly A_{G} are indicated in FIG. 15 by the pairs of block arrows P₄ and P_{5.}

The rotational axis connection of the motor-gearbox sub-assembly A_{G} with the base element K_{B} can alternatively also be realized directly by engagement of the output shaft S_{O} with a recess of corresponding shape in the base element K_{B}. This can be seen, for example, in FIG. 6, where the drawing-related lower end of the output shaft S_{O} simultaneously supports the link pin L_{S1} for the pivotable guidance of the inner swivel arm A_{Si}, and also forms the rotational axis connection C_{R} between the motor-gearbox sub-assembly A_{G} and the base element K_{B} with respect to the fixation of the degrees of freedom of movement of the motor-gearbox sub-assembly A_{G} visualized in FIG. 15 by means of the block arrows P₃, in that according to FIG. 6 the output shaft S_{O} is in positive engagement at C_{CB2} with the gearbox holder H_{G} and possibly also at C_{B1} with the connecting bracket C_{B} (cf. also FIG. 8).

The horizontal translational stop connection C_{T1}, visualized in FIG. 15 by means of the block arrows P₄, comes into positive contact with a recess R_{L} of the gearbox holder H_{G} (cf. FIG. 10) when the motor-gearbox sub-assembly A_{G} is mounted in the base element K_{B} and thus forms the torque support for dissipating the engine counter-torque into the base element K_{B}. The further vertical translational stop connection C_{T2}, visualized in FIG. 15 by means of the block arrows P₅ is positively enclosed in the base element K_{B}, for example between the gearbox holder H_{G} and the connecting bracket C_{B}, in the vertical direction as shown in the drawing, and thus fixes the motor-gearbox sub-assembly A_{G} in the vertical direction in the base element K_{B}. The vertical fixing of the motor-gearbox sub-assembly A_{G} in the base element K_{B} can also be achieved by other stop surfaces arranged on the outside of the housing of the motor-gearbox sub-assembly A_{G}, which come into contact with corresponding mating stop surfaces of the base element K_{B} when the motor-gearbox sub-assembly A_{G} is mounted in the base element K_{B}.

FIG. 16 shows a motor-gearbox sub-assembly A_{G} according to FIG. 14 or FIG. 15, together with battery device or exchangeable battery U_{B} according to FIG. 2, 6, 7, 8 or 15 in longitudinal section. In addition to some parts of the base element K_{B}, namely gearbox holder H_{G} and connecting bracket C_{B}, it is possible to see in particular the positive fixing of the exchangeable battery U_{B}, which, as shown in the drawing, takes place on the left-hand side by means of a nose protrusion N_{P1} formed on the housing of the exchangeable battery U_{B}, which engages under a retaining sleeve S_{R} formed on the connecting bracket C_{B}. On the right-hand side as shown in the drawing, the interchangeable battery U_{B} is secured in the base element K_{B} by means of the latching lever L_{L}, which is connected to the gearbox holder H_{G} so that it can pivot about a latching lever pivot axis A_{L} arranged on the gearbox holder H_{G}, and engages positively by means of an integrally formed nose protrusion N_{P2} and by generating an elastic clamping force F_{E} over a latching protrusion P_{L} integrally formed on the interchangeable battery U_{B}. The elastic clamping force F_{E} is generated by elastic deformation of both the latching lever L_{L} and the housing of the interchangeable battery U_{B} as well as the two housing halves S_{H1} and S_{H2} of the motor-gearbox sub-assembly A_{G}.

However, the latching lever LL has a vertically extending oblong hole H_{O} as shown in the drawing for pivotable connection to the latching lever pivot axis A_{L}, which in turn is rigidly connected to the gearbox holder H_{G} (see FIG. 10). This means that the positive elastic tensioning F_{E} of the latching lever L_{L} is not initially introduced via the pivot axis A_{L} into the gearbox holder H_{G} and is only transferred from the latter to the lower housing half S_{H1} of the motor-gearbox sub-assembly A_{G}, from there to the upper housing half S_{H1}, and finally back to the housing of the interchangeable battery U_{B}, resulting in a long tolerance chain with the risk of either too tight or too loose tensioning F_{E} of the interchangeable battery U_{B}, or undesirably large changes in this clamping force F_{E} over time.

Due to the oblong hole H_{O}, however, the latching lever L_{L} can move up and down in a vertical direction relative to the drawing. The elastic clamping force F_{E} is thus generated only shortly before the final latching of the latching lever L_{L} due to direct contact of an inclined attachment surface S_{A1}, arranged for this purpose on the latching lever L_{L}, with a counter-pressure surface S_{A2}, arranged in a corresponding shape on the gearbox holder H_{G} (cf. FIGS. 6, 8, 9, 10 and 15). In this way, a maximum shortened tolerance chain results for the attachment of the exchangeable battery U_{B} by the latching lever L_{L} on the direct path of the force F_{E} between the attachment surface S_{A1} of the latching lever L_{L} over lower and upper housing flanges F_{H1}, F_{H2} of the housing halves S_{H1} and S_{H2} of the motor-gearbox sub-assembly A_{G}, and via the housing of the exchangeable battery U_{B} and its nose protrusion N_{P2} back onto the latching lever L_{L}. This leads to a minimum addition of tolerances and thus to a secure and permanently reproducible mounting of the interchangeable battery U_{B} on the motor-gearbox sub-assembly A_{G}. or in the base element K_{B}.

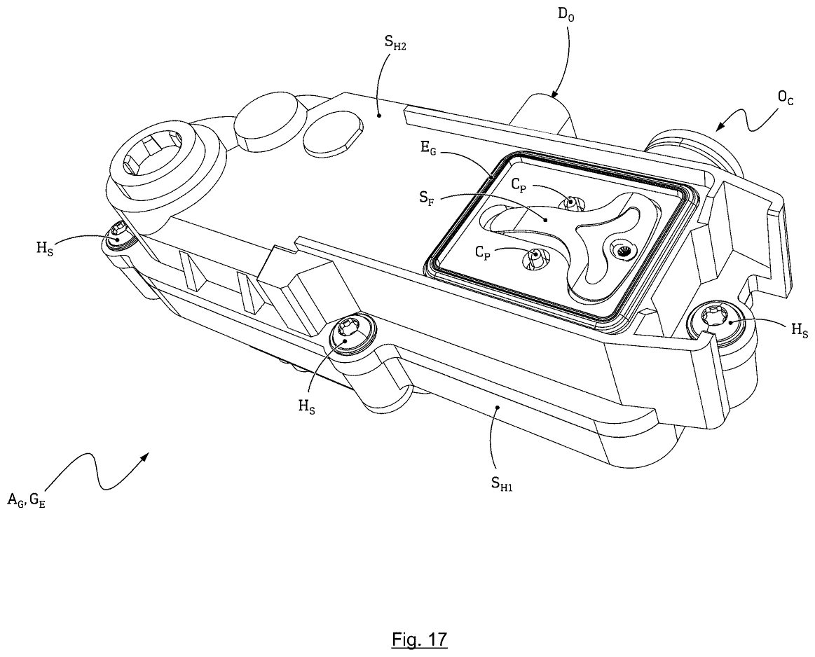

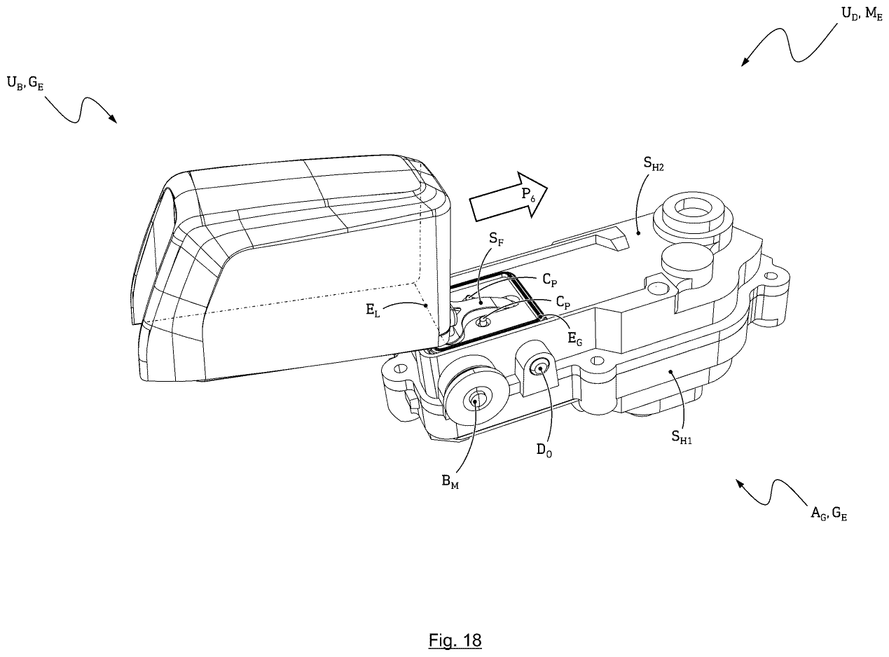

FIGS. 17 and 18 show the motor-gearbox sub-assembly according to FIG. 14 or 15 or according to FIG. 16, respectively, in oblique perspective top views of the electrical contact device of the motor-gearbox sub-assembly, which has contact pins C_{P} on its upper side for electrical contact between the exchangeable battery U_{B} and the motor-gearbox sub-assembly A_{G}.

In addition to the two housing halves S_{H1} and S_{H2} of the motor-gearbox sub-assembly A_{G} and the contact pins C_{P} arranged on the upper housing half S_{H2}, a circumferential elastomer gasket EG can be seen, which ensures reliable protection of both the drive-side contact pins C_{P} and the corresponding mating contact surfaces on the exchangeable battery U_{B}. The contact pins C_{P} on the drive side are spring-loaded metal pins whose spring loading ensures reliable current transmission.

To prevent damage or bending of the contact pins C_{P}, for example by contact with the leading edge EL of the exchangeable battery U_{B}, when the battery is pushed on, which according to FIG. 18 takes place in the longitudinal direction as shown by the block arrow P₆, i.e. essentially horizontally in the illustrations of FIGS. 15 to 19 (see also FIG. 16), the contact pins C_{P} are protected by a flexion spring S_{F}, which ensures that the leading edge E_{L} of the interchangeable battery U_{B} is slightly raised when the battery is pushed on and can thus slide over the contact pins C_{P} without risk of bending.

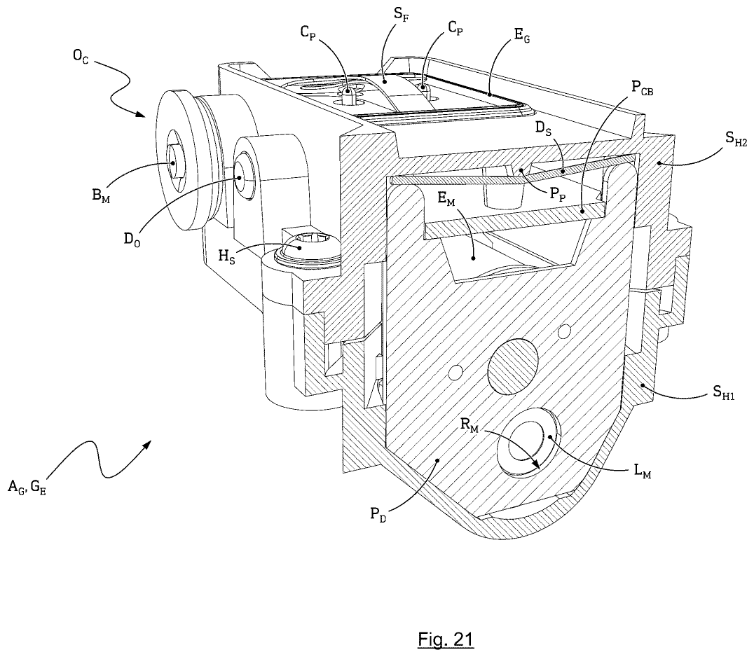

When the interchangeable battery U_{B} is finally locked by means of the latching lever L_{L} (cf. FIG. 18), the flexion spring S_{F} is pressed down accordingly, and the contact pins C_{P} can contact corresponding mating contact surfaces on the underside of the interchangeable battery U_{B} without any problems. The protection provided by the flexion spring S_{F} for the contact pins C_{P} against bending when the interchangeable battery U_{B} is pushed on can also be seen particularly well in FIG. 21.

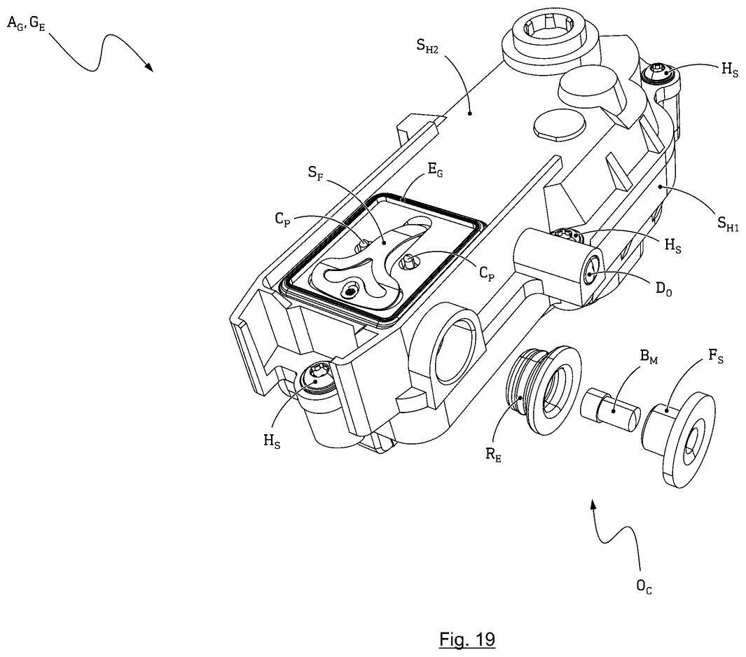

FIG. 19 shows the motor-gearbox sub-assembly according to FIG. 14 or FIGS. 15 to 18 in an oblique perspective view from above/outboard, with an exploded view of the actuating device O_{C}. It can be seen that the actuating device O_{C} is characterized by the small number of only three individual parts, namely by the actuating button B_{M}, furthermore a rigid cover sleeve F_{S} and an elastomer receptacle R_{E}. In addition to the resulting low-cost production and assembly, the individual parts B_{M}, F_{S} and R_{E} of the operating control O_{C} are designed to ensure both the movable, captive enclosure of the operating control B_{M} in the cover sleeve F_{S} and a permanently sealed mechanical connection of the operating control O_{C} to the housing S_{H2} of the motor-gearbox sub-assembly A_{G}. This saves production and assembly costs and ensures that the operating control O_{C} functions reliably over the long term.

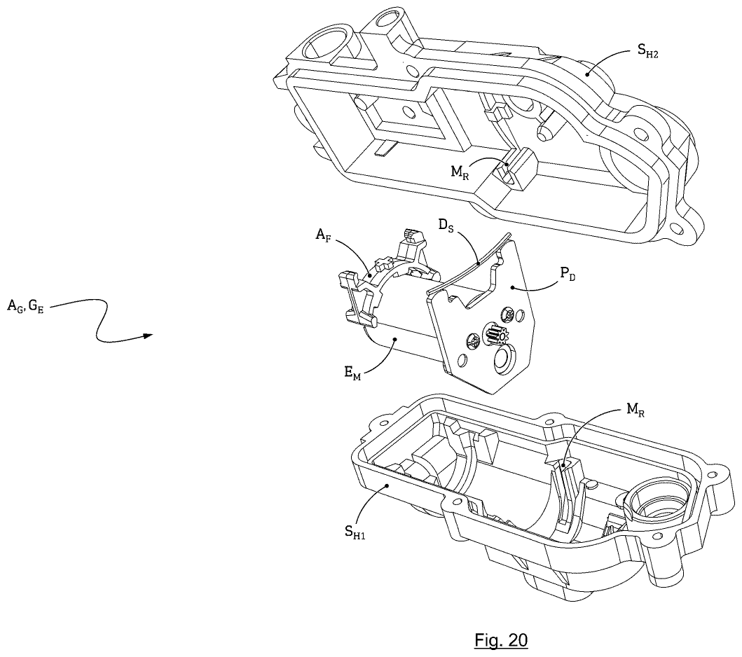

In FIG. 20, the motor-gearbox sub-assembly A_{G} according to FIG. 14 or FIGS. 15 to 19 is shown in an oblique perspective view in a partially disassembled state. For the sake of clarity, various parts or assemblies have been omitted from the illustration in FIG. 20, in particular connecting elements between the two housing halves S_{H1} and S_{H2} of the motor-gearbox unit A_{G} as well as most of the electronic and gearbox components contained in the motor-gearbox unit A_{G}.

It can be seen that the electric motor E_{M} is mounted in the housing S_{H1}, S_{H2} of the motor-gearbox sub-assembly A_{G} by means of a carrier plate device P_{D} (cf. FIG. 21), whereby the electric motor E_{M} is first screwed to the carrier plate device P_{D} for assembly, and then the unit comprising the electric motor E_{M} and the carrier plate device P_{D} is merely inserted into corresponding, essentially prismatically shaped mating receptacles M_{R}, which are molded into the two housing halves S_{H1}, S_{H2} of the motor-gearbox sub-assembly A_{G}. A spring device D_{S} ensures that the unit comprising the electric motor E_{M} and the carrier plate device P_{D} is fixed in the housing S_{H1}, S_{H2} of the motor-gearbox sub-assembly A_{G} in a dimensionally defined and permanently backlash-free manner.

The latter can be seen particularly clearly in the illustration of FIG. 21, which shows the motor-gearbox sub-assembly A_{G} according to FIG. 14 or FIGS. 15 to 20 in the mounted state in a sectional perspective view, in which, among other things, the carrier plate device P_{D} and the spring device D_{S} are shown in section. It can be seen that a push projection P_{P} arranged in the interior of the upper housing half S_{H2} pretensions the spring device D_{S} downwards when the housing S_{H1}, S_{H2} is closed by the housing screws H_{S} as shown in the drawing, as a result of which the carrier plate device P_{D} and the electric motor E_{M} screwed to the carrier plate device P_{D} are exactly defined in terms of their position in the gear housing S_{H1}, S_{H2} and fixed without play. The electric motor E_{M} is also fixed in its rear area by the auxiliary fixture A_{F}.

FIG. 21 further shows the position of the electronic circuit board P_{CB}, on which the components (not shown) of the electronic control of the bicycle derailleur R_{D} are arranged.

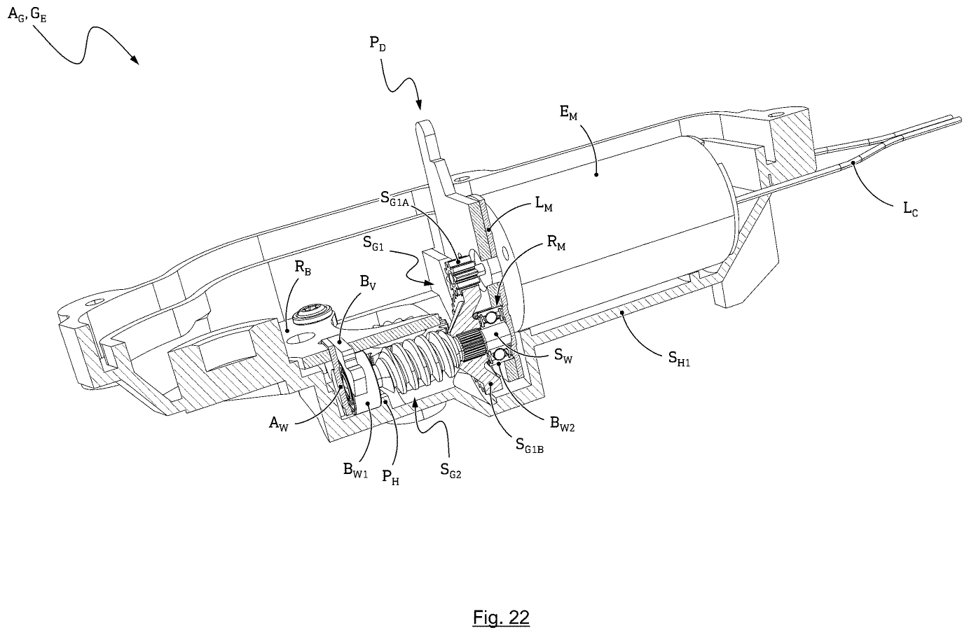

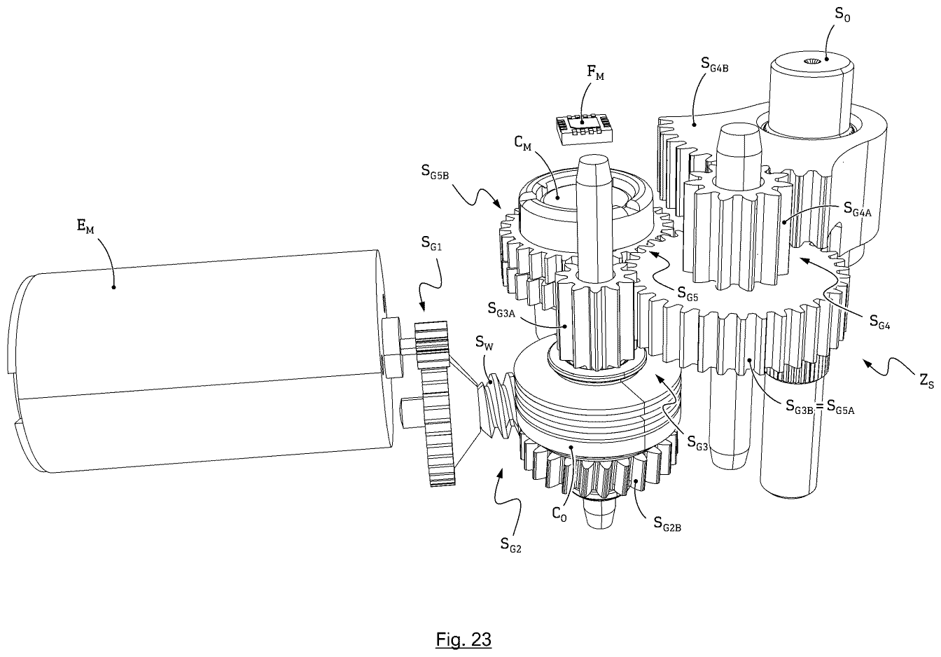

FIG. 22 shows the motor-gearbox sub-assembly A_{G} according to FIG. 14 or FIGS. 15 to 21 in a partially mounted state in a perspective longitudinal sectional view. Here, among other things, the upper housing half S_{H2} and the majority of the gearbox components (cf. FIGS. 23 to 25) are omitted for clarity. The electrical connection line L_{C} of the electric motor E_{M} visible in FIG. 22 is merely symbolic with regard to the embodiments shown in the figures, since in these embodiments the control electronics P_{CB} of the rear derailleur R_{D} (cf. FIG. 21), and thus also the electrical connection line LC, like the electric motor E_{M} itself, is arranged completely in the housing of the motor-gearbox sub-assembly A_{G}.

FIG. 22 again shows the motor mounting in the gearbox housing S_{H1}, S_{H2} by means of the carrier plate device P_{D}, as well as the design of the first two gear stages S_{G1}, S_{G2} of the motor-gearbox sub-assembly A_{G}, in particular the bearing of the worm shaft S_{W}. This comprises two shaft bearings B_{W}, which in the embodiment shown are designed as ball bearings but can also be in the form of plain bearings, in particular sintered bearings.

The bearing arrangement shown, using two ball bearings B_{W1}, B_{W2}, is configured in the axial direction of the worm shaft S_{W} as a locating/non-locating bearing arrangement. The drawing-related left-hand ball bearing B_{W1} is fixed by means of a plate-shaped bearing seat retainer R_{B} screwed to the lower housing half S_{H1}, and in the axial direction by means of an axial stop A_{W}, which is also plate-shaped and is held at the top by the bearing seat retainer R_{B} and at the bottom in a mounting recess of the lower housing half S_{H1}, and by means of a housing protrusion P_{H} of the lower housing half S_{H1}. In the radial direction, the left ball bearing B_{W1} is clamped between the bearing seat retainer R_{B} and the lower housing half S_{H1} by means of a vertical bracket B_{V}. This way, the left ball bearing B_{W1} is fixed in the lower housing half S_{H1} without play both in the axial direction and in the radial direction, relative to the worm shaft S_{W}.

The drawing-related left-hand ball bearing B_{W1} can, for example, form a floating bearing arrangement of the worm shaft S_{W} in that, for example, a transition fit is selected for receiving the drawing-related left-hand bearing journal of the worm shaft S_{W} in the bearing inner ring of the left-hand ball bearing B_{W1}, so that the left-hand bearing journal of the worm shaft S_{W} can move in the axial direction relative to the left-hand ball bearing B_{W1} and can thus, for example, compensate for axial stresses occurring due to tolerances or temperature changes.

The ball bearing B_{W2} on the right in relation to the drawing is pressed without play in the radial direction into a mounting recess RM of the motor carrier plate device P_{D} (cf. FIG. 3), and its position in the axial direction to the right in relation to the drawing is fixed in the embodiment shown by a second material layer L_{M} of the motor carrier plate device P_{D} covering the area of the ball bearing at the rear (cf. also FIG. 21). The bearing journal of the worm shaft S_{W} on the right-hand side as shown in the drawing is, for example, pressed firmly into the bearing inner ring of the associated ball bearing B_{W2}, in the sense of a fixed bearing of the worm shaft S_{W} in the axial direction.

In this way, the worm shaft S_{W} is fixed with exactly defined dimensions relative to the gear housing S_{H1} and in particular relative to the respective adjacent gear components of the two gear stages S_{G1}, S_{G2}. The maximum forces occurring in the gearbox during operation of the rear derailleur R_{D} act to the right on the worm shaft S_{W} due to the shift logic of the rear derailleur R_{D} in the gearbox as shown in FIG. 22, and can thus be transmitted reliably and with minimum backlash into the transmission housing S_{H1}, S_{H2} via the component chain “right end of worm shaft S_{W}”->“second gearwheel S_{G1B} of the first gear stage SG1”->“ball bearing B_{W2}”->“carrier plate device P_{D}”. Alternatively or additionally, such reaction forces acting on or in the worm shaft S_{W} to the right can also be introduced directly into the second material layer L_{M} of the motor carrier plate device P_{D} through a right-hand spherical end of the worm shaft S_{W}.

Simpler, less expensive designs of the gear unit can also use sintered sleeve bearings instead of the ball bearings B_{W1}, B_{W2}, for example. In this case in particular, the worm shaft S_{W} can also be mounted axially on both sides in a floating bearing arrangement and thus axially cantilevered, with the ends of the worm shaft S_{W}, which are crowned on both sides for example, abutting either on the right side against the motor carrier plate device P_{D} or on the left side against the axial stop A_{W} of the bearing seat retainer R_{B}, depending on the force effect.

When considering the transmission of the bicycle derailleur R_{D}, it should also be noted that the illustrations according to FIGS. 14 to 25 are all enlarged, in some cases greatly enlarged. In the embodiment of the transmission shown, for example, the bearing journals of the worm shaft S_{W} have a diameter of only 2 mm, which means that the bicycle derailleur R_{D} in question clearly falls into the field of precision mechanics for the person skilled in the art.

FIG. 23 again shows the electric motor as well as the complete gearbox of the motor-gearbox sub-assembly A_{G} according to FIG. 14 or FIG. 15 to 22 in a perspective view without housing. The first gear stage S_{G1} already described above with reference to FIG. 22 and the worm shaft S_{W} of the second gear stage S_{G2} are again visible. In the second gear stage S_{G2}, the worm shaft S_{W} acts on a helical spur gear S_{G2B}, which acts on a spur gear S_{G3A} of the third gear stage S_{G3} via an overload detent coupling C_{O} indicated schematically here. From there, the drive torque is transmitted via a fourth gear stage S_{G4} comprising a stepped gear Z_{S} with toothing S_{G3B}=S_{G5A} and S_{G4A} to a segmented gear S_{G4B}, which is pressed onto the output shaft S_{O}. As described above and shown in particular in FIGS. 6 and 13 to 15, the output shaft S_{O} drives the drive arm A_{D} by means of a direct connection, thus driving the shifting element parallelogram P_{S} and thus the translatory pivoting movement of the shifting element or P-knuckle K_{P}.

FIG. 23 further shows a fifth gear stage S_{G5} arranged on a fifth (not shown) gear shaft with a double spur gear S_{G5B}. The fifth gear stage S_{G5} is used for backlash-free transmission of the rotational angle position of the segment gear wheel S_{G4B}, thus the angular position of the drive arm A_{D}, and thus in turn of the rear derailleur parallelogram P_{S}, ultimately thus an exact transmission of the horizontal shifting position of shifting element K_{P} and chain cage C_{G} relative to the sprocket cassette C_{S} of the bicycle (cf. FIGS. 1 and 3) to a corresponding angular position of the double spur gear S_{G5B}.

For this purpose, a magnetic component CM is accommodated, for example pressed, in the double spur gear S_{G5B}, which communicates its rotational position via (not drawn) magnetic field lines to an electronic magnetic field sensor F_{M}, which is fixed relative to the housing S_{H1}, S_{H2} of the motor-gearbox sub-assembly A_{G}, for example arranged on the circuit board P_{CB}, which is accommodated in the gearbox housing S_{H1}, S_{H2}, cf. the electronics circuit board PC_{B} shown in section in FIG. 21. Gearbox housing S_{H1}, S_{H2} and electronics circuit board PC_{B} are omitted for clarity in the illustration of FIG. 23.

Since the gear stages S_{G4}, S_{G3} and S_{G2} are generally under a force preload resulting from the spring effect of the swivel arm spring S_{AS} in the direction of rotation resulting from the winding direction of the swivel arm spring S_{AS} (cf. FIG. 6), any backlash of these gear stages S_{G4} to S_{G2} up to the corresponding stop of the tooth flanks of the helical gear S_{G2B} on the corresponding mating tooth flanks of the worm shaft S_{W} is already eliminated both at standstill and in normal operation of the rear derailleur R_{D}.

The fifth gear stage S_{G5} with the double spur gear S_{G5B} used for the rotational drive of the magnetic component C_{M} thus only has to eliminate its own backlash with respect to the stepped gear Z_{S} in order to map the swivel or horizontal position L_{P} of the chain cage C_{G} (cf. FIG. 3) to a corresponding angular position of rotation of the magnetic component C_{M} with a high degree of precision and without backlash.

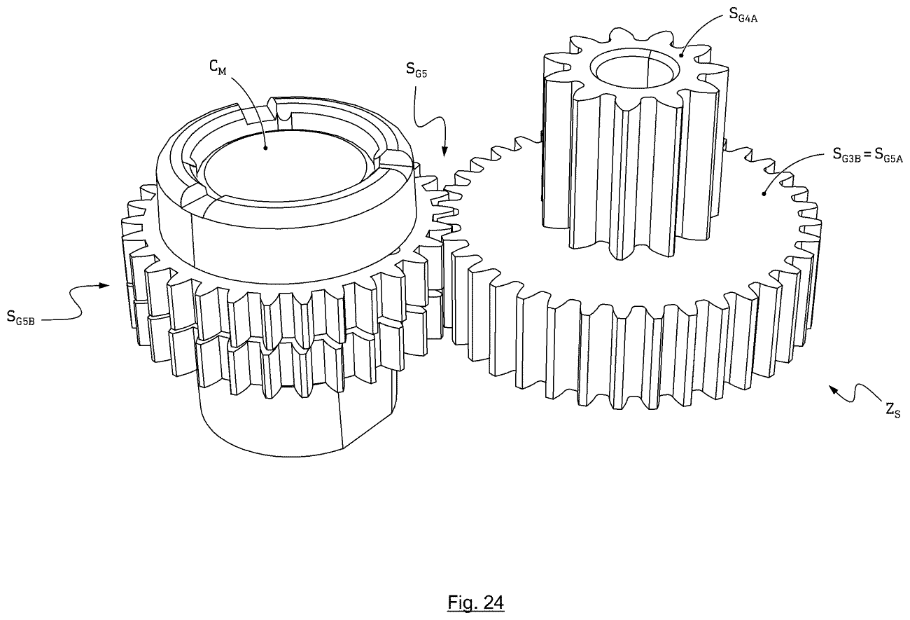

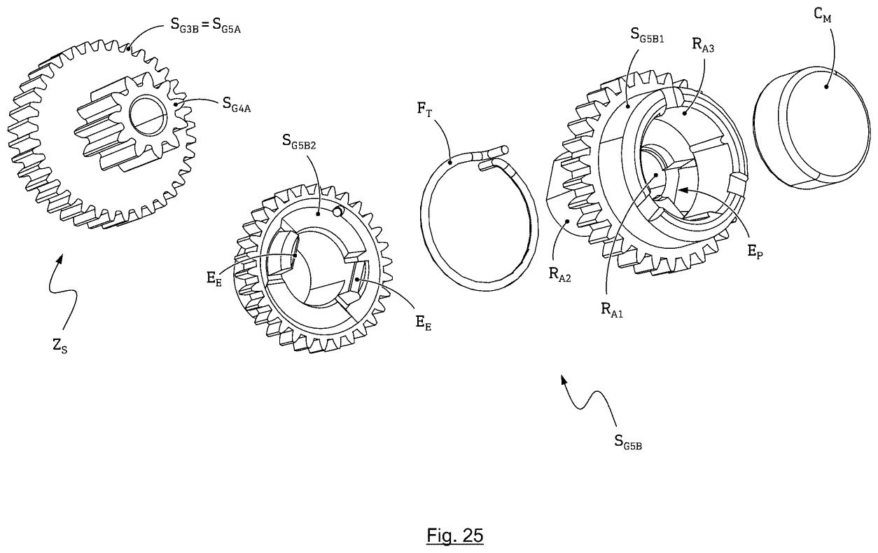

FIGS. 24 and 25 show the double helical gear S_{G5B} again in a further enlarged view, whereby the stepped gear Z_{S} is additionally shown in each case, with whose toothing S_{G3B}=S_{G5A} the double helical gear S_{G5B} meshes without backlash.

FIG. 25 shows the configuration of the double spur gear S_{G5B} consisting of only exactly three individual parts S_{G5B1}, S_{G5B2} and F_{T}, which comprises a main gear S_{G5B1}, an auxiliary gear S_{G5B2} and a tensioning spring F_{T}.

The main gear S_{G5B1} provides both an inner cylindrical bearing face R_{A1} for rotational mounting of the double spur gear S_{G5B} on an associated (not shown) fifth gear shaft, and an outer cylindrical bearing face R_{A2} for rotational mounting of the auxiliary gear S_{G5B2} on the main gear S_{G5B1}, and also an inner cylindrical bearing face R_{A3}, in which the magnetic component C_{M} is press-fitted, cf. FIG. 24.

The main gear S_{G5B1} and auxiliary gear S_{G5B2} of the double spur gear S_{G5B} are locked together with respect to their relative axial position shown in FIG. 24 by a snap-in connection E_{E}, E_{P} by means of two elastic snap-in elements E_{E} arranged on the auxiliary gear S_{G5B2} and pointing radially inwards, in that the elastic snap-in elements E_{E} snap into shape-corresponding, radially outward-pointing snap-in projections E_{P} of the main gear S_{G5B1} when the main gear S_{G5B1} and auxiliary gear S_{G5B2} are axially joined. The elastic snap-in elements E_{E} and the shape-corresponding snap-in projections E_{P} are shaped and their extent in the circumferential direction of the main gear S_{G5B1} and auxiliary gear S_{G5B2} is selected such that the main gear S_{G5B1} and auxiliary gear S_{G5B2} can still rotate relative to each other by a few angular degrees even in the locked state.

When main gear S_{G5B1} and auxiliary gear S_{G5B2} are joined, the tensioning spring F_{T} is also received in a cavity formed by main gear S_{G5B1} and auxiliary gear S_{G5B2}, with the two spring ends of the tensioning spring F_{T} being received in corresponding recesses of main gear S_{G5B1} and auxiliary gear S_{G5B2}, respectively, in such a way that the tensioning spring F_{T} is under a certain preload which tends to rotate the main gear S_{G5B1} and auxiliary gear S_{G5B2} relative to one another.

This preload or spring-loaded relative rotation of main gear S_{G5B1} or S_{G5B2} ensures that, in the case of the gear pair S_{G5} between the double spur gear S_{G5B} and the stepped gear Z_{S} meshing with it, not only one of the two tooth flanks of the gear pair S_{G5} is in contact with the corresponding mating flank of the other gear, but that both tooth flanks of this gear pair S_{G5} are in contact with each other, eliminating the backlash. In this way, an exact and backlash-free mapping of the horizontal position L_{P} of the chain cage C_{G} of the bicycle derailleur R_{D} (cf. FIG. 3) to a corresponding rotational angle position of the double spur gear S_{G5B} and thus of the magnetic component C_{M} is ensured.

As can be seen in particular from the illustration in FIG. 23, the electronic control of the rear derailleur, which in an embodiment is located on the circuit board PC_{B} in the transmission housing S_{H1}, S_{H2} (cf. FIG. 21), knows the exact horizontal or swivel position L_{P} of the chain cage C_{G} at all times (cf. FIG. 3). Since the overload clutch C_{O} of the gear unit according to FIG. 23 is arranged between the stepped gear Z_{S} and the worm gear stage S_{G2}, this also applies in principle if the shift position L_{P} of the rear derailleur R_{D} should be adjusted by strong external forces, for example in the event of a fall or by hitting an obstacle.

In such a case, the electronic control PC_{B} of the rear derailleur R_{D} can, after a short pause or triggered by the user, be moved again exactly to the previously assumed shift position L_{P}, or also to any other desired gear or shift position, without any loss of shifting precision being associated with the previously occurring, adjustment of the rear derailleur R_{D} by massive external forces.

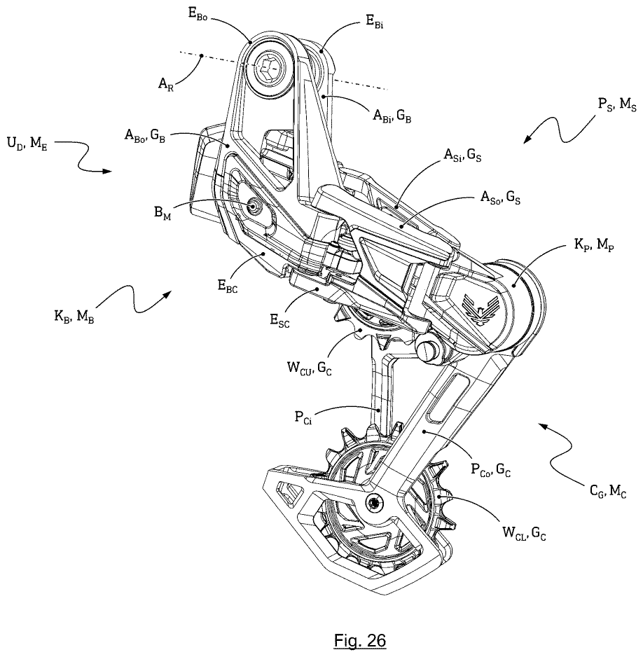

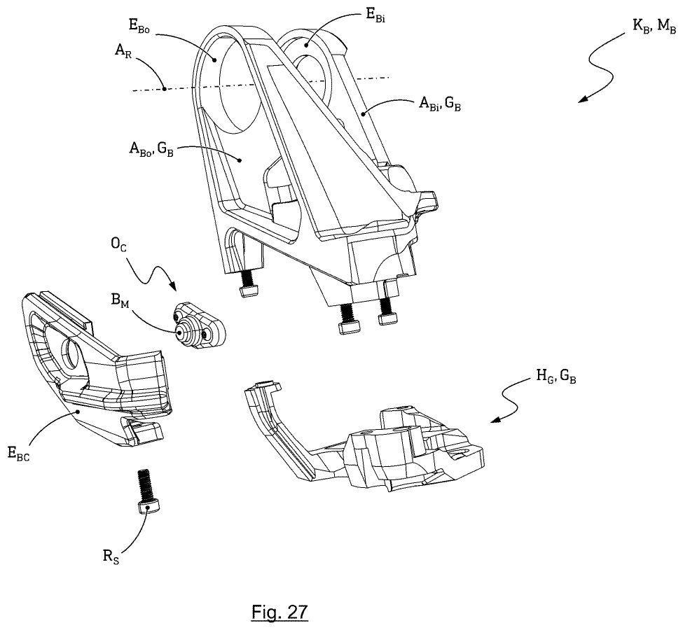

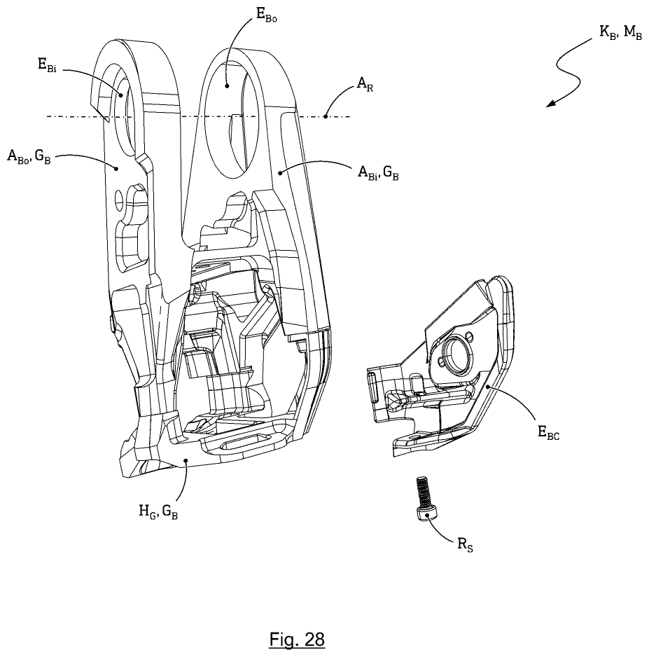

FIGS. 26 to 30 show a further embodiment of a bicycle rear derailleur R_{D} according to the present disclosure. As can be seen from FIGS. 26 to 28, this rear derailleur R_{D} has a cover element E_{BC} which can also be easily replaced by the user and in an embodiment is made of a polymer material. In the embodiment shown, the cover element E_{BC} is penetrated by the button B_{M} of the operating control O_{C}, which is used for the selection of certain operating modes of the electric rear derailleur R_{D} by the user. In the embodiment shown, the cover element E_{BC} is connected to the structure of the base element K_{B} by means of snap-in elements formed by elastic rear grips, which can be seen in particular in FIG. 28, and is additionally secured by means of a retaining screw R_{S}, which in the embodiment shown can be screwed into a lower component of the base element K_{B}.

The cover element E_{BC} is shaped and arranged in such a way that it can absorb the typical damage that frequently occurs to bicycle rear derailleurs R_{D} during operation, for example due to falls, due to the bicycle falling over or due to contact with obstacles such as tree branches, roots or stones during sporting use, and thus protect the other parts of the rear derailleur R_{D}, in particular metallic parts, painted or polished parts or high-quality plastic parts, for example made of fiber composites, such as carbon materials, from such damage. In this way, proper functioning and a high-quality appearance of the bicycle rear derailleur R_{D} can be preserved for a longer period of time or permanently, and in the event of damage, the cover element E_{BC}, in particular by the end user himself, can be easily replaced.

Likewise, it is possible and intended to provide cover elements E_{BC} made of varied materials, with different shaping, with different surface design or with additional functions, such as tool receptacles, etc. In this way, the user can upgrade the bicycle rear derailleur R_{D} again even after a longer period of time or, similar to the replacement of other modules or sub-assemblies described in the present disclosure, upgrade to a higher-quality version of the rear derailleur R_{D}.

In this way, resources can be saved again, the service life of the bicycle derailleur R_{D} can be increased and the reparability by the end customer himself or by specialist workshops is facilitated and improved.

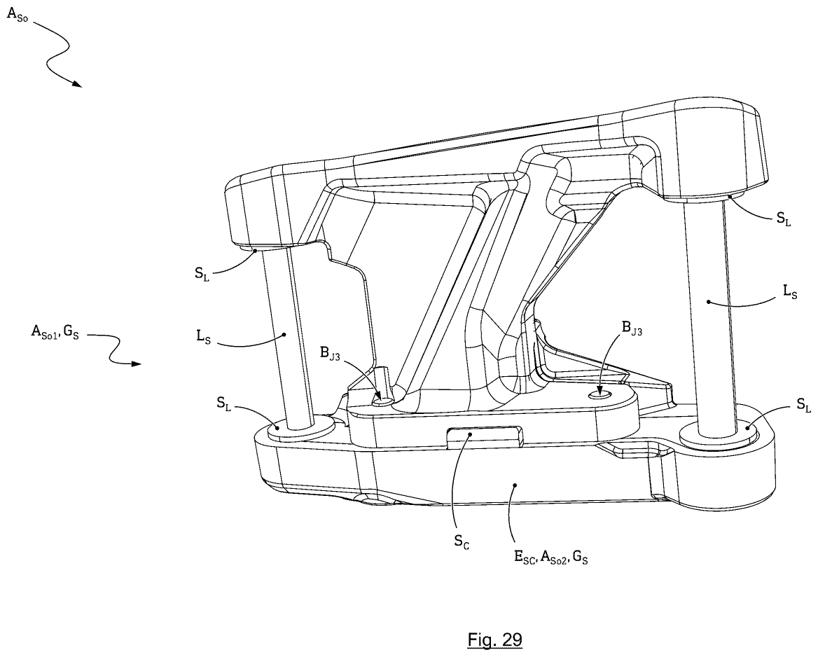

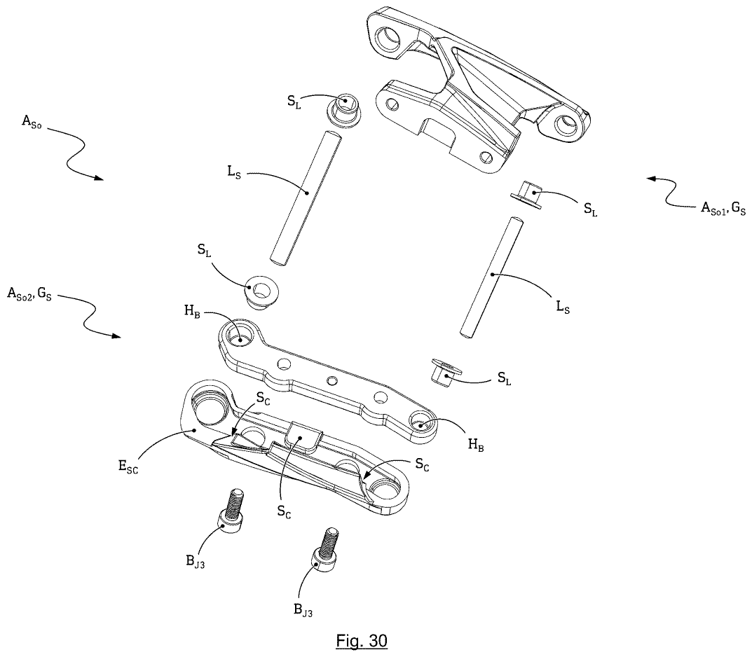

FIG. 29 shows an outer swivel arm or parallelogram arm A_{So} of the rear derailleur R_{D} according to FIGS. 26 to 28 in perspective view from inboard, while the parallelogram arm A_{So} in FIG. 30 is shown in a disassembled exploded view.

The parallelogram arm A_{So} of the rear derailleur R_{D} according to FIGS. 26 to 28 shown in FIGS. 29 and 30 is initially of similar structure as the parallelogram arm A_{So} described above with reference to FIG. 12. The parallelogram arm A_{So} according to FIGS. 29 and 30 is also essentially composed of two parts, swivel arm sub-assemblies A_{So1} and A_{So2}, and further comprises link pins L_{S} accommodated in bearing sleeves S_{L}.

The swivel arm sub-assemblies A_{So1} and A_{So2} are connected or bolted together by means of two connecting bolts B_{J3}. The lower swivel arm sub-assembly A_{SO2} again has a cover element E_{SC} protecting the parallelogram arm, or swivel arm A_{So}, which can be connected to the lower swivel arm sub-assembly A_{So2} by means of undercuts and/or snap connections S_{C}, similar to FIG. 13. The cladding element E_{SC} protects the other (and in an embodiment metallic) components of the parallelogram arm A_{So} from damage and can be easily replaced in the event of damage or wear, in particular also by the end user.

In contrast to the parallelogram arm A_{So} shown in FIGS. 11 to 13, which can be removed without tools from the rear derailleur R_{D} according to FIG. 13, the parallelogram arm A_{So} according to FIGS. 29 and 30 must first be removed from the rear derailleur R_{D} by loosening the joining bolts B_{J3} and separating the upper swing arm sub-assembly A_{So1} from the lower swing arm A_{So2}, since the parallelogram arm A_{So} according to FIGS. 26 and 30 does not have through holes H_{T} for the link pins L_{S} in its lower swing arm sub-assembly A_{So2}, as does the parallelogram arm A_{So} according to FIGS. 11 to 13, but is provided with blind holes H_{B} at this position.

FIG. 31 shows a shifting element or P-knuckle K_{P} of a rear derailleur R_{D} according to FIG. 2 or according to FIG. 26, whereby according to FIG. 31 the spring/damper device D_{P} of the rear derailleur R_{D} is removed from the receptive housing R_{H} of the shifting element K_{P}.

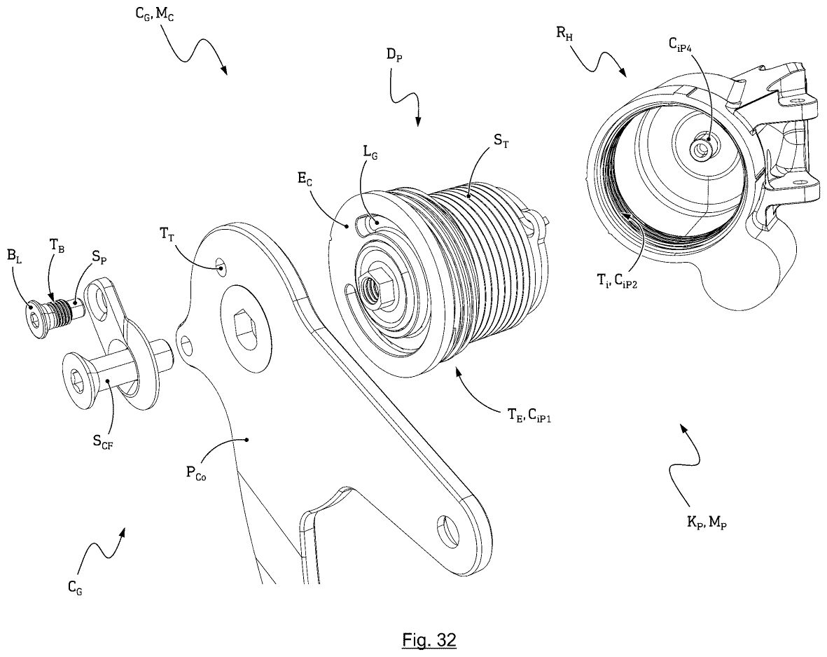

In the rear derailleurs according to the present disclosure, the spring/damper device D_{P}, as shown in FIG. 31, is present as a module that can be handled or removed in one piece, which is also shown, for example, in FIGS. 7 and 32. In another embodiment, the spring/damper device D_{P} is designed together with the chain cage device C_{G} as an sub-assembly that can be handled as a single piece, which corresponds to the spring/damper device D_{P} in FIG. 7, which is drawn in dashed lines and provided with bracketed reference signs.

This makes it considerably easier to unscrew the spring/damper device D_{P} from the receptive housing R_{H} of the base element K_{B} due to the large lever arm formed by the chain cage device C_{G}. For this purpose, among others, the chain cage device C_{G} has a limit stop bolt B_{L} protruding in the inboard direction or in the direction of the spring/damper device (cf. FIG. 7 and FIG. 33), which is inserted into a stop groove L_{G} visible in FIGS. 6, 7 and 33, and thus permits torque transmission from the chain cage device C_{G} to the spring/damper device D_{P} for the purpose of unscrewing the spring/damper device D_{P} from the receptive housing R_{H}.

This means that the spring/damper device D_{P} can also be removed without tools from the receptive housing R_{H} of the base element K_{B}, for example in order to be able to repair or replace the spring/damper device D_{P} in the event of damage. Furthermore, it is also possible and intended with regard to the spring/damper device D_{P} to provide spring/damper devices D_{P} with different functional characteristics which can be acquired by the customer optionally or as a spare part and exchanged with one another or with a respective existing spring/damper device D_{P}, for example, in the sense of an upgrade of their bicycle derailleur R_{D}. In particular, this refers to spring/damper devices D_{P} with, for example, a mechanical friction damper on the one hand and a higher-quality hydraulic damper on the other, or with mechanical friction dampers of different construction, weight and quality.

The torque transmission from the chain cage device C_{G} to the spring/damper device D_{P} for the purpose of unscrewing the spring/damper device D_{P}, together with the chain cage device C_{G}, from the base element housing R_{H} using the chain cage device C_{G} as a torque-generating handle is again shown in FIG. 32. The limit stop bolt B_{L} can be seen, which is screwed by means of its bolt thread T_{B} into a corresponding through-hole thread T_{T} of the outer chain cage guide plate device P_{Co} in such a way that the end of the limit stop bolt B_{L}, which is designed as a stop peg S_{P}, engages in the stop groove L_{G} when the outer chain cage guide plate P_{Co} is connected to the damper module D_{P} by means of a cage fastening screw S_{CF}.

Thus, by rotating the chain cage device C_{G} by hand in an anticlockwise direction, a sufficiently high torque can be applied to the cover element E_{C} via the end of the stop pin B_{L} designed as a stop peg S_{P} and via the upper end of the stop groove L_{G} shown in FIG. 32 in relation to the drawing, in order to be able to unscrew it from the base element housing R_{H} by means of the thread T_{E}. Screwing in is conducted in the same way, although in this case the torque is transmitted via the end of the limit stop bolt B_{L}, which is designed as a stop peg S_{P}, and via the lower end of the stop groove L_{G} as shown in FIG. 32.

After unscrewing, the chain guiding device module M^{C} including the spring/damper device D_{P} is available as a module that can be handled as a single piece, as shown in FIG. 33. Due to the design of the spring/damper device D_{P}, the cage spring S^{T} remains tensioned and adjusted unchanged, as does the damper device arranged radially inside the cage spring S^{T} and not visible in the figures. The design and function of the spring/damper device D_{P} are not the subject of the present disclosure but can be found in other patent applications of the applicant, for example the German patent application DE1020209370A1.

As can be seen in FIGS. 31 to 34, the spring/damper device D_{P} is connected to the receptive housing R_{H} of the base element K_{B} by means of a multi-start thread T_{E}, Tᵢ. In the embodiment shown, the thread is a three-start thread T_{E}, Tᵢ, which can be seen in particular in the illustration of FIG. 34, which shows a view of the inside of the receptive housing R_{H} of the base element K_{B}, with the spring/damper device removed.

By looking at FIGS. 31, 33 and 34 together, a distinctive feature of the three-start thread T_{E}, Tᵢ of the embodiment shown becomes clear. In the three-start thread T_{E}, Tᵢ, one of the screw threads has been omitted in the thread area T_{O} of both the external thread T_{E} and the internal thread Tᵢ. In other words, this means that the remaining two screw threads T_{S1} and T_{S2} of the here actually three-thread pairing T_{E}, Tᵢ are not evenly spaced from each other both in the axial direction according to FIG. 31 and in the circumferential direction according to FIG. 32, in each case with reference to the pivot axis A_{P} of the chain cage device C_{G} (cf. FIG. 2, 3 or 6).

Advantageously, this means that the thread pair T_{E}, Tᵢ cannot be screwed into one another in the three different rotational relative positions 120 angular degrees apart, which are usual for a three-start thread, but only in one rotational relative position, which is the correct rotational relative position of spring/damper device D_{P} and receptive housing R_{H} of the base element K_{B} provided for in the design. In this way, incorrect assembly of the chain guiding device module M_{C} with the spring/damper device D_{P} arranged thereon can be reliably avoided.

FIG. 35 shows three differently constructed spring/damper devices D_{P1}, D_{P2}, D_{P3} for a modular rear derailleur R_{D} similar to FIG. 2 or FIG. 26. The components shown in FIG. 35 are at least partially drawn schematically and not to scale. In the illustration of FIG. 35, the spring/damper devices D_{P1}, D_{P2}, D_{P3} are installed in three receptive housings R_{H1}, R_{H2}, R_{H3} which are also differently constructed or shaped. The various spring/damper devices D_{P1-3} can be different damper modules such as, for example, dampers with belleville washer spring W_{B} and roller freewheel R_{F} (FIG. 35 center), dampers with directionally damping wrap springs W_{S} (FIG. 35 left and right) or hydraulic dampers (not shown).

In accordance with the at least two-level hierarchical modular construction system M_{CS} according to the present disclosure, the three different spring/damper devices D_{P1}, D_{P2}, D_{P3} are present in the form of modularly interchangeable and one-piece manageable (cf. FIGS. 31 and 32) sub-assemblies G, in this case of three (P1-P3) first (G1) sub-assemblies G1_{P1}, G1_{P2}, G1_{P3}, which are assigned (P) to the shifting element module M_{P}, cf. the overview of the modular system M_{CS} in FIG. 7 with the shifting element module M_{P} at the top left, which also shows a spring/damper device D_{P1} as the first sub-assembly G1_{P} of the shifting element module M_{P}.

As shown in FIG. 7, in the embodiment of the modular system M_{CS} shown there, the shifting element module M_{P} includes a spring/damper device D_{P} and a receptive housing R_{H} as sub-assemblies G_{P} of the module M_{P}. Both the spring/damper device D_{P} and the receptive housing R_{H} can be handled as a single piece, cf. FIGS. 31 and 32.

Furthermore, according to FIG. 35, both the three spring/damper devices D_{P1}, D_{P2} and D_{P3}, and the three receptive housings R_{H1}, R_{H2}, and R_{H3} form respective sub-assembly families S_{C1}, S_{C2} of the shifting element module M_{P}, cf. analogously the family S_{B} comprising two family members S_{B1}, S_{B2} according to FIG. 7 from first sub-assemblies G1_{B1}, G1_{B2} of the base element module M_{B}.

In FIG. 35, the two sub-assembly families S_{C1}, S_{C2} of the shifting element module M_{P}, which corresponds to the P-knuckle or shifting element K_{P} of the rear derailleur R_{D}, are framed with dotted lines (S_{C1}) or marked for display purposes (S_{C2}) in accordance with the representation of the sub-assembly family S_{B} in FIG. 7.

After FIG. 7, FIG. 35 thus shows a further example of the at least two-level hierarchical modular construction system M_{CS} according to the present disclosure. In the embodiment example according to FIG. 35, the first stage of the hierarchical two-level modularity lies in the modules M_{P1}, M_{P2} and M_{P3}, which can be handled as a single piece and are interchangeable with one another and contain three different B-knuckles or circuit elements K_{P1}, K_{P2} and K_{P3} with identical interfaces C_{CP} to neighboring modules across modules (cf. FIG. 7), and thus form a module family F_{P} (with regard to the one-piece or one-piece manageability of the circuit elements K_{P} or circuit element modules M_{P}, cf. FIG. 7, FIGS. 31 and 32). The circumference of the module family F_{P}, here comprising the one-piece manageable and interchangeable p-knuckle or circuit element modules M_{P1}, M_{P2} and M_{P3}, is visualized in FIG. 35 by the thicker dashed line F_{P}.

The second stage of the at least two-level hierarchical modularity of the modular construction system M_{CS} is realized with the three (P1-P3) first (G1) shifting element (P) sub-assemblies G1_{P1}, G1_{P2} and G1_{P3}, which can also be handled as a single piece and are interchangeable with one another in a modular manner, or with the three (P1-P3) second (G2) shifting element (P) sub-assemblies G2_{P1}, G2_{P2} and G3_{P3}, which respectively form spring/damper devices D_{P} and receptive housings R_{H} of a shifting element module M_{P} (with regard to the one-piece or one-piece manageability also of the spring/damper devices D_{P} and the receptive housings R_{H}, cf. again FIG. 7, FIGS. 31 and 32).

With the interfaces C_{iP1}, C_{iP2} C_{iP3}, C_{iP4} (cf. FIGS. 31 to 34), which are identical across modules, to the respective neighboring modules G_{P} of the same module M_{P} (cf. FIG. 7 and FIG. 31 to 34) and with identical interfaces C_{CP1}, C_{CP2} (cf. FIG. 7) and C_{CP3} to the neighboring modules M_{S} and M_{C}, the sub-assemblies G1_{P1-3} and G2_{P1-3} form two sub-assembly families S_{C1} and S_{C2} within the shifting element module M_{P}.

Thus, in the embodiment according to FIG. 35, three different spring/damper devices D_{P1}, D_{P2}, D_{P3} and three different base element receptive housings R_{H1}, R_{H2}, R_{H3} are available, which can be interchanged or combined with each other in any modular way within the shifting element module M_{P}, which already leads to nine different possible combinations and thus different versions of the shifting element module M_{P}. The same applies to the other base element modules M_{B}, swivel formation module M_{S}, chain guiding device module M_{C} and electric module M_{E} (see FIG. 7).

It can thus be seen that due to the at least two-level hierarchical modularity of the rear derailleur R_{D} or the modular construction system M_{CS} according to the present disclosure, a large number of variants of the rear derailleur R_{D} can be formed, whereby rear derailleurs with a wide variety of product properties and-capabilities as well as with a wide variety of material and surface qualities can be represented in a simple manner. This allows the rear derailleur R_{D} to be modularly adapted as freely as possible to the requirements of a wide variety of market segments and customer groups.

The desired ease of repair of the rear derailleur R_{D} is also realized in this way. It is no longer necessary to replace the entire rear derailleur if a module or sub-assembly is damaged or defective, but the corresponding module or sub-assembly can be repaired or replaced very easily by a wide range of user groups, including the end customer. Likewise, the customer or an owner of such a rear derailleur R_{D} can equip their rear derailleur with additional functions or higher-quality sub-assemblies G or modules M as required without having to replace the entire rear derailleur. This leads to a considerably lower overall consumption of materials and resources during the life cycle of the rear derailleur R_{D}, which can be extended almost indefinitely in this way.

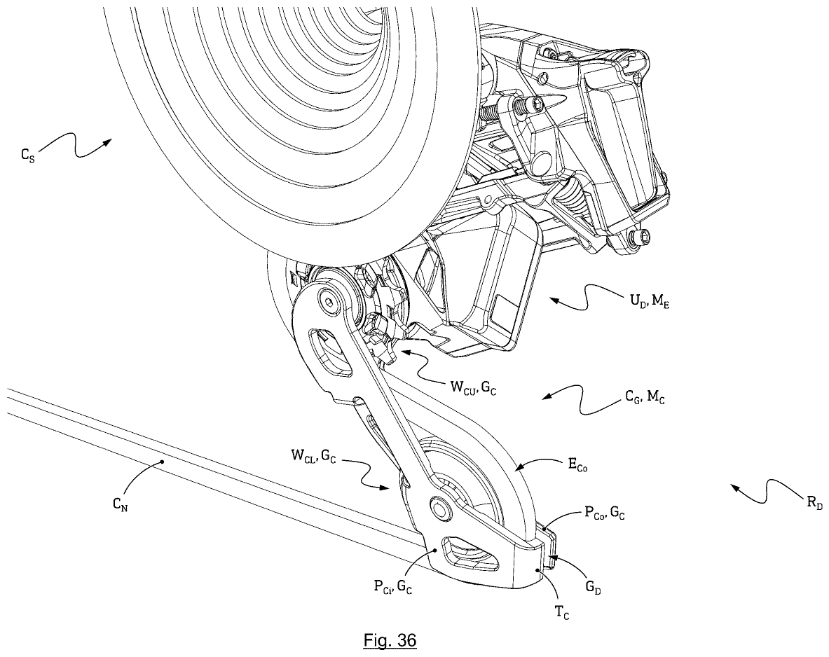

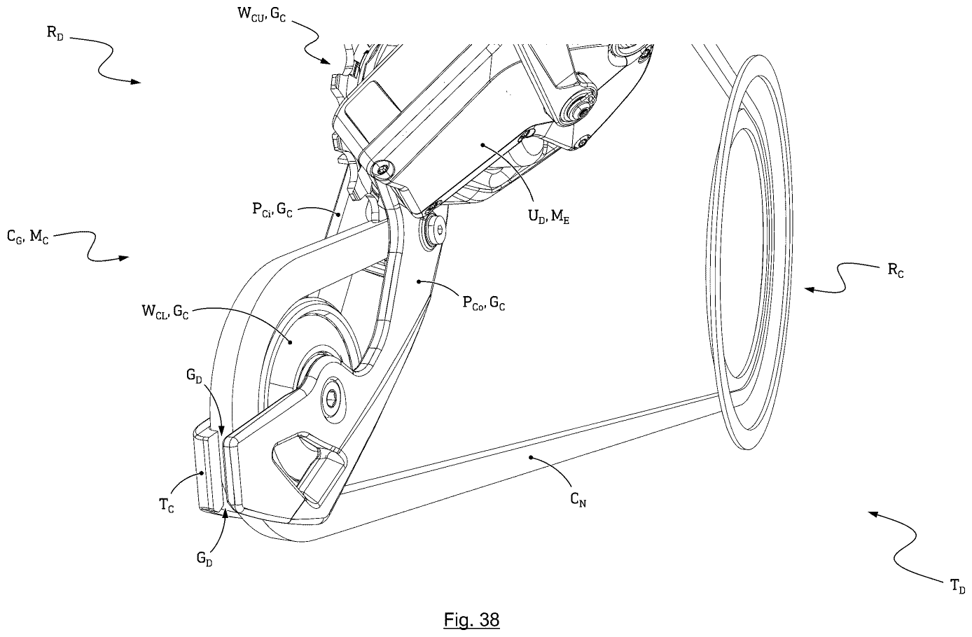

FIGS. 36, 38 and 39 show a further embodiment of an electric bicycle derailleur R_{D}. This bicycle derailleur R_{D} is provided with a lower chain tensioning pulley W_{CL} which has no teeth.

Due to the toothing omitted from the chain tensioning pulley W_{CL}, it is no longer possible for the chain C_{N} to ride up on the teeth of the chain tensioning pulley W_{CL}, as is the case with the prior art (cf. FIG. 36). For this reason, in the prior art, the chain guiding device C_{G} between the lower chain tensioning pulley W_{CL} and a chain cage guide tab T_{C} closing the chain cage must have a sufficiently large tab distance D_{T} from the teeth of the chain tensioning pulley W_{CL} or from the outer enveloping surface E_{Co} of the chain C_{N}. The tab distance D_{T} must be large enough to allow the chain C_{N} to pass between the chain cage guide tab T_{C} and the lower chain tensioning pulley W_{CL} even if the chain C_{N} rides on the teeth of the chain tensioning pulley W_{CL}, since jamming of the chain in the chain cage can easily lead to a derailleur break.

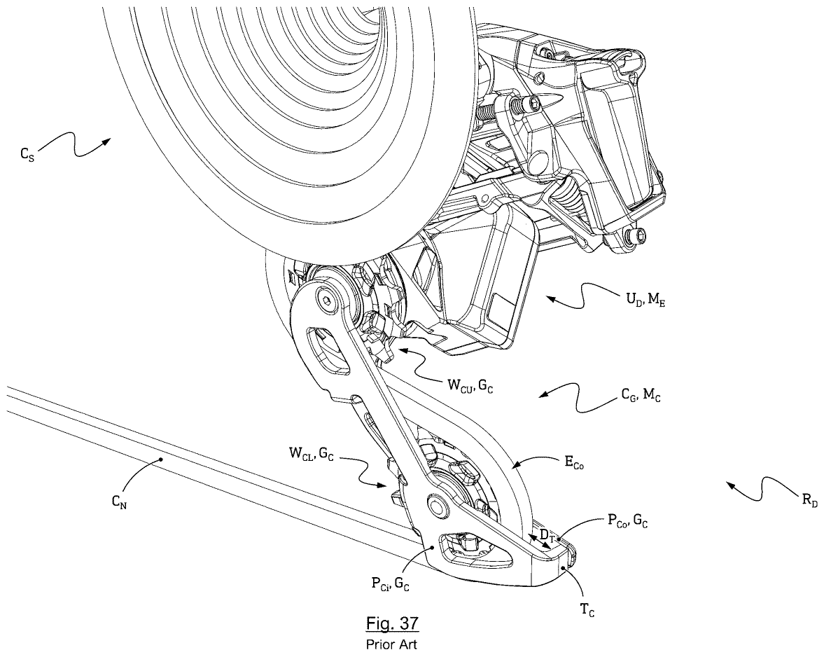

In the bicycle derailleur R_{D} according to FIGS. 35, 37 and 38, which has a smooth, non-toothed lower chain tensioning pulley W_{CL}, the chain C_{N} has an always constant radial distance position from the chain tensioning pulley W_{CL}. Therefore, the chain cage guide tab T_{C} can be positioned much closer or directly at the outer envelope surface E_{Co} of the chain C_{N}, which is particularly clear not only from FIG. 35 but also from FIG. 37. This results in improved and safer guidance of the empty strand of the chain C_{N} when entering the rear derailleur R_{D} in all driving conditions.

In this embodiment, the chain cage tab T_{C} is formed in such a way that a substantial gap G_{D} remains between the chain cage tab T_{C} and the opposite chain cage guide plate device P_{CO}, which can also be taken from FIGS. 35 and 37. This gap allows dirt adhering to the chain or, for example, entrained plant parts such as small branches etc. to be easily ejected from the chain cage again without clogging it, which could otherwise lead to the derailleur breaking.

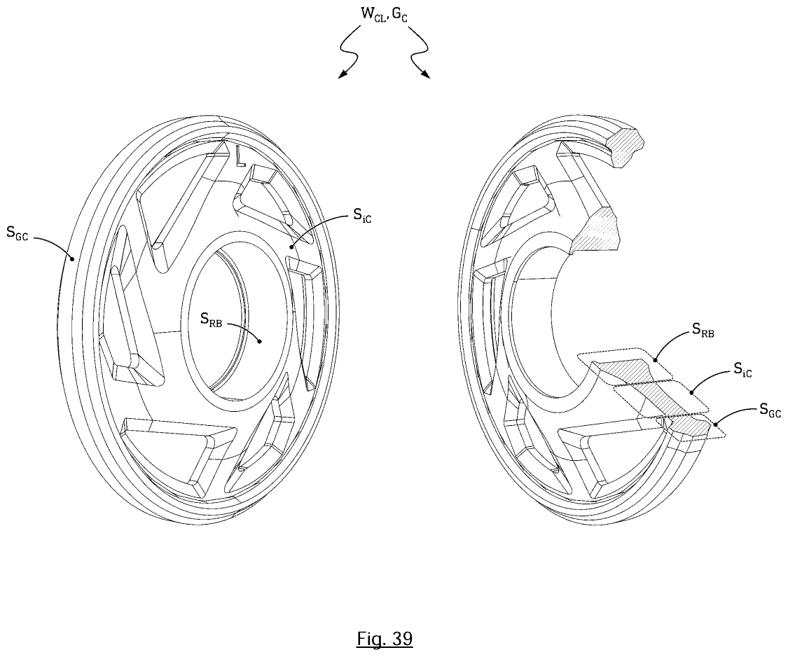

FIG. 39 shows the lower chain tensioning pulley W_{CL} of the rear derailleur embodiment according to FIGS. 35, 37 and 38 separately. A bearing receiving section SR_{B} can be seen positioned radially inward for the arrangement of a plain or ball bearing, further a non-toothed, smooth chain guiding section S_{GC} and an interconnecting structure section S_{iC}, which connects the bearing receiving section SR_{B} and the chain guiding section S_{GC} to one another.

Since the lower chain tensioning pulley W_{CL} only serves to pretension the chain C_{N} and, unlike the upper chain tensioning pulley W_{CU}, does not have to perform specific lateral chain guide tasks, in particular during the shifting process, the omission of the toothing on the lower chain tensioning pulley W_{CL} does not involve any disadvantages.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A motor-gearbox assembly for a rear derailleur, the motor-gearbox assembly comprising:
a housing enclosing an electric motor and gear assembly,
wherein the housing is configured for connection to a base element of the rear derailleur by exactly one rotational axis connection and exactly two translational stop connections,
thereby constraining all six spatial degrees of freedom of the motor-gearbox assembly relative to the base element in three-dimensional space without being statically under or over constrained.

2. The motor-gearbox assembly of claim 1, wherein the rotational axis connection comprises cylindrical housing beads, and the translational stop connections each comprising a pair of opposing contact surfaces.

3. The motor-gearbox assembly of claim 1, further comprising an operating control assembly including
an actuating button for user interaction,
a rigid cover sleeve, and
an elastomer receptacle,
wherein the operating control assembly is held together by press-fit engagement between the cover sleeve and the elastomer receptacle, and
the operating control assembly is configured to be press-fitted into a motor-gearbox housing opening without requiring separate fastening components,
the actuating button being axially movably retained between the cover sleeve and the elastomer receptacle.

4. The motor-gearbox assembly of claim 1, further comprising a protector configured as a flexion spring to shield battery contact pins of the motor-gearbox assembly from lateral impacts during battery installation.

5. A motor-gearbox assembly, comprising a latching mechanism for securing a replaceable battery to a housing of the motor-gearbox assembly, the latching mechanism including:
a latching lever configured to be pivotably retained on a base element of the rear derailleur,
a housing protrusion on the housing configured for engagement with the latching lever,
a latching protrusion on the battery housing configured for locking engagement with the latching lever,
wherein housing protrusion, latching lever, and latching protrusion are configured to form a closed loop force transmission path generating clamping force between battery and housing, ensuring fixation with minimized tolerance chain accumulation.

6. The motor-gearbox assembly of claim 5, wherein the latching lever is pivotably retained with play on the base element via an elongated hole allowing guided displacement along the latching lever's longitudinal axis, thereby compensating for mechanical tolerances between the housing and the base element.

7. The motor-gearbox assembly of claim 5, wherein the latching lever and the housing protrusion comprise corresponding slanted contact surfaces configured for engagement to generate a defined clamping force upon completion of the latching lever's locking movement.

8. The motor-gearbox assembly of claim 5, further comprising a protector configured as a flexion spring to shield battery contact pins of the motor-gearbox assembly from lateral impacts during battery installation.

9. The motor-gearbox assembly of claim 5, further comprising an operating control assembly including
an actuating button for user interaction,
a rigid cover sleeve, and
an elastomer receptacle,
wherein the operating control assembly is held together by press-fit engagement between the cover sleeve and the elastomer receptacle, and
the operating control assembly is configured to be press-fitted into a motor-gearbox housing opening without requiring separate fastening components,
the actuating button being axially movably retained between the cover sleeve and the elastomer receptacle.

10. A motor-gearbox assembly for a rear derailleur, comprising:
an electric motor and gear assembly,
a housing with at least two housing parts, configured for enclosing the electric motor and gear assembly,
the electric motor being configured to be secured in the housing via a carrier plate device,
the carrier plate device being configured for pre-assembly with the motor prior to integration into the housing,
wherein the carrier plate device and motor pre-assembly is configured to be guided into its final position by mating receptacles of the housing parts, ensuring automatic final alignment and fixation of carrier plate device and motor pre-assembly therein without additional adjustment.

11. The motor-gearbox assembly of claim 10, further comprising a spring device exerting a defined preload force on the carrier plate device when the housing parts are assembled, achieving play-free fixation of the carrier plate device and motor pre-assembly in the housing.

12. The motor-gearbox assembly of claim 11, wherein the electric motor is additionally stabilized by an auxiliary fixture mounted in a rear section region of the electric motor to restrict unintended movement of the electric motor.

13. The motor-gearbox assembly of claim 10, further comprising an operating control assembly including
an actuating button for user interaction,
a rigid cover sleeve, and
an elastomer receptacle,
wherein the operating control assembly is held together by press-fit engagement between the cover sleeve and the elastomer receptacle, and
the operating control assembly is configured to be press-fitted into a motor-gearbox housing opening without requiring separate fastening components,
the actuating button being axially movably retained between the cover sleeve and the elastomer receptacle.

14. The motor-gearbox assembly of claim 10, further comprising a protector configured as a flexion spring to shield battery contact pins of the motor-gearbox assembly from lateral impacts during battery installation.

15. A motor-gearbox assembly for a rear derailleur, comprising:
a backlash-free gear transmission system including a sensor gear stage with a spring-loaded double spur gear in meshing engagement with another spur gear;
wherein the spring-loaded double spur gear structurally integrates both the backlash-free torque transmission and a magnetic encoder by carrying a magnet element for direct rotational position feedback.

16. The motor-gearbox assembly of claim 15, wherein the magnet element is embedded within a bearing face of the spring-loaded double spur gear, ensuring rigid positional relationship to the double spur gear's rotation.

17. The motor-gearbox assembly of claim 15, wherein the spring-loaded double spur gear comprises two axially split gear halves configured to be interconnectable by a snap-fit mechanism, forming a pre-assembled unit incorporating a preloaded biasing spring for eliminating backlash.

18. The motor-gearbox assembly of claim 15, wherein the preloaded biasing spring is embedded between the gear halves, to form a compact, pre-assembled unit, facilitating handling, space efficiency, and gear transmission assembly.

19. The motor-gearbox assembly of claim 15, further comprising an operating control assembly including
an actuating button for user interaction,
a rigid cover sleeve, and
an elastomer receptacle,
wherein the operating control assembly is held together by press-fit engagement between the cover sleeve and the elastomer receptacle, and
the operating control assembly is configured to be press-fitted into a motor-gearbox housing opening without requiring separate fastening components,
the actuating button being axially movably retained between the cover sleeve and the elastomer receptacle.

20. The motor-gearbox assembly of claim 15, further comprising a protector configured as a flexion spring to shield battery contact pins of the motor-gearbox assembly from lateral impacts during battery installation.
